(19) United States
(12) Patent Application Publication
(10) Pub. No.: US 2025/0350905 A1
(43) Pub. Date: Nov. 13, 2025

(54) ALL-DAY LOCATION DISCOVERY WITH PROACTIVE MEASUREMENT

(71) Applicant: Apple Inc., Cupertino, CA (US)

(72) Inventors: Mojtaba Bahrami, San Jose, CA (US); Aditya N. Srivastava, Fremont, CA (US); Andrew J. Kerns, Cupertino, CA (US); Isaac T. Miller, Half Moon Bay, CA (US); Arjun Ram Subramani Purushothaman, Sunnyvale, CA (US)

(73) Assignee: Apple Inc., Cupertino, CA (US)

(21) Appl. No.: 19/056,621

(22) Filed: Feb. 18, 2025

Related U.S. Application Data
(60) Provisional application No. 63/646,425, filed on May 13, 2024.

(51) Int. Cl. H04W 4/02; H04W 4/029

(52) U.S. Cl. CPC H04W 4/027; H04W 4/029

(57) ABSTRACT

The mobile device can preserve battery capacity by periodically determining locations only when the mobile device is moving between locations where the mobile device is relatively static. To conserve power, the mobile device's application processor may be in a low-power mode. Until a wake event, the device's low power auxiliary processor can store inertial information in a buffer. At each wake event, the inertial information can be classified to determine a distance, a direction, and a movement type (e.g., driving or walking). The mobile device may also record a wireless fingerprint. This wireless fingerprint and the classified inertial information can be used to detect that the mobile device has left a dwell point. Until the mobile device reaches a new dwell point, the mobile device's application processor can log the device's GNSS location at each wake event to create the log of the device's location during its journey.

### CROSS-REFERENCES TO OTHER APPLICATIONS

This application claims priority to U.S. Provisional Application No. 63/646,425, for “ALL-DAY LOCATION DISCOVERY WITH PROACTIVE MEASUREMENT” filed on May 13, 2024, which is herein incorporated by reference in its entirety for all purposes.

### BACKGROUND

A moving mobile device can determine its location using a global navigation satellite system (GNSS). Such location information can be useful for performing various operations on the phone. However, GNSS location determinations require energy intensive processing by an application processor. This processing can drain the mobile device's battery capacity, and determining such location information can take substantial time reduces responsiveness of the mobile device.

### SUMMARY

The mobile device can preserve battery capacity by periodically determining locations (also referred to as “breadcrumbing”) only when the mobile device is moving between dwell points. A dwell point (e.g., a home or work) can be a location where the mobile device is relatively static (e.g., the device's net displacement is below a threshold). To conserve power, the mobile device's application processor may be in a low-power mode when the processor is not in use. Until a wake event causes the application processor to leave the low-power mode, the device's low-power auxiliary processor can store inertial information in a buffer.

At each wake event, the inertial information can be classified to determine a distance, a direction, and a movement type (e.g., driving or walking) for the inertial information. The mobile device may also record a wireless fingerprint indicating the available wireless access points, the signal strength for each access point, and any access points that are connected or not connected to the mobile device. This wireless fingerprint and the classified inertial information can be used to detect that the mobile device has left a dwell point. Until the mobile device reaches a new dwell point, the mobile device's application processor can log the device's GNSS location at each wake event to create a log of the device's location during its journey.

A system of one or more computers can be configured to perform particular operations or actions by virtue of having software, firmware, hardware, or a combination of them installed on the system that, in operation, cause, or cause the system, to perform the actions. One or more computer programs can be configured to perform particular operations or actions by virtue of including instructions that, when executed by a data processing apparatus, cause the apparatus to perform the actions.

One general aspect includes a method performed by one or more processors of a mobile device. The method includes measuring, using first location technology, first location data of the mobile device during a first time period. The method also includes measuring, using a second location technology, second location data of the mobile device during the first time period. The method also includes providing the first location data and the second location data to a location controller. The method also includes generating, using the location controller, a first location using the first location data, the first location being defined within map tiles of a geographic map of an area. The method also includes generating, using the location controller, a second location using the second location data, the second location being defined within the map tiles of the geographic map of the area. The method also includes determining, using the location controller, a final location using the first location and the second location. The method also includes providing the final location to a software routine executing on the mobile device.

Another general aspect includes a method performed by one or more processors of a mobile device. The method also includes measuring, using first location technology, first location data of the mobile device during a first time period. The method also includes measuring, using a second location technology, second location data of the mobile device during the first time period. The method also includes measuring, using a motion sensor, motion information of the mobile device. The method also includes computing a first error value based on a first difference between the motion information and the first location data. The method also includes computing a second error value based on a second difference between the motion information and the second location data. The method also includes assigning a first weight to the first location data based on the first error value. The method also includes assigning a second weight to the second location data based on the second error value. The method also includes determining a final location using the first location data, the first weight, the second location data, and the second weight. The method also includes providing the final location to a software routine executing on the mobile device.

In one general aspect, disclosed techniques may include performing, by an auxiliary processor, first inertial measurements using one or more inertial sensors of the mobile device during a first time period, while an application processor is in a low power state. The auxiliary processor (e.g., always-on processor) is powered on more often than the application processor. The techniques may also include storing, by the auxiliary processor, the first inertial measurements in a buffer for subsequent processing by the application processor, after exiting the low power state. The techniques may, furthermore, include, after exiting the lower power state, classifying, by the application processor, the first inertial measurements stored in the buffer to obtain the first inertial classifications. The classifying can be performed in response to a wake event that causes the application processor to leave the low-power state. The first inertial classifications can have a distance, a direction, and a motion type corresponding to the first inertial measurements. The techniques may, in addition, include detecting, by the application processor and based on the first inertial classifications and a wireless fingerprint, a preliminary exit trigger indicating that the mobile device has left a first dwell point. The techniques may, moreover, include, responsive to the preliminary exit trigger indicating that a mobile device has left a first dwell point, and performing GNSS measurements using the GNSS circuitry of the mobile device. The GNSS measurements can be performed at a first active rate. These techniques can include corresponding operations, methods, computer systems, apparatuses, and computer programs recorded on one or more computer storage devices, memories, or non-transitory computer readable media, each configured to perform the actions of the techniques.

These and other embodiments of the disclosure are described in detail below. For example, other embodiments are directed to systems, devices, and computer readable media associated with methods described herein.

A better understanding of the nature and advantages of embodiments of the present disclosure may be gained with reference to the following detailed description and the accompanying drawings.

### BRIEF DESCRIPTION OF THE DRAWINGS

FIG. 1 is a schematic diagram of a communication system, according to various embodiments.

FIG. 2 is a block diagram of the user equipment, according to various embodiments.

FIG. 3 is a functional diagram of the user equipment, according to various embodiments.

FIG. 4 is a simplified diagram illustrating a technique for selecting and switching between location technologies, according to some embodiments.

FIG. 5 is a simplified diagram illustrating an example system for determining locations, according to some embodiments.

FIGS. 6A and 6B are simplified diagrams illustrating multiple hypotheses with location data fusion and hypothesis selection, according to some embodiments.

FIG. 7 is a diagram illustrating a high-level architecture of a location controller, according to some embodiments.

FIG. 8 is a diagram illustrating the pipeline stages of a fusion/selection system of a location controller, according to some embodiments.

FIG. 9 is a flowchart illustrating a method for performing location data fusion and hypothesis selection of a location controller, according to some embodiments.

FIG. 10 is a flowchart illustrating a method for applying a weighting mechanism when performing location data fusion and hypothesis selection of a location controller, according to some embodiments.

FIG. 11 is a flowchart illustrating a method for applying a weighting mechanism when performing location data fusion and hypothesis selection of a location controller, according to some embodiments.

FIG. 12 is a simplified diagram of an architecture for GNSS navigation, according to various embodiments.

FIG. 13 shows a simplified diagram of an architecture for estimating the position of a mobile device, according to at least one embodiment.

FIG. 14 is a simplified diagram showing a mobile device traveling between dwell points, according to various embodiments.

FIG. 15 is a sequence diagram showing a technique for identifying exit events, according to various embodiments.

FIG. 16 is a flowchart illustrating a method for identifying exit events, according to various embodiments.

FIG. 17 shows a technique for training a machine learning model, according to at least one embodiment.

FIG. 18 shows an example machine learning model of a neural network, according to at least one embodiment.

FIG. 19 is a block diagram of an example always-on system architecture, according to at least one embodiment.

FIG. 20 is a block diagram of an example electronic device, according to at least one embodiment.

### DETAILED DESCRIPTION

Certain embodiments are directed to techniques (e.g., a device, a method, a memory or non-transitory computer readable medium storing code or instructions executable by one or more processors) for determining a location of a mobile device using odometry and communication with other devices, such as satellites or wireless access points.

Location-based actions occur in short sessions in the background, such as turning lights on/off or an AirTag separating from an owner. Technologies, such as GPS and Wi-Fi, work well in typical situations. For example, using GPS while driving outdoors works well. However, there are instances where using one technology alone is not ideal, especially in an indoor environment. Sometimes, it is difficult to know which technology is reliable for a particular situation at a specific moment.

Techniques are disclosed that enable a location controller in a mobile device to fuse multiple location providers to provide a reliable location estimate. The disclosed techniques for a location controller of a mobile device can fuse location data from different location providers/technologies (e.g., GPS, cell, and Wi-Fi), when their data is available in various environments (e.g., indoor and outdoor, moving and stationary), and make a smooth transition between these different location technologies. The disclosed techniques may form one or more hypotheses, based on the location data received from the location providers, and select the most likely hypothesis to output a location estimate. A location estimate may include a particular location and an estimate of the position the mobile device is heading or moving. In some embodiments, weighting mechanisms may be applied to the location data from the location providers.

In addition, a mobile device may wish to selectively perform GNSS navigation in order to conserve the device's power. GNSS navigation can be energy intensive and the mobile device's battery consumption can be reduced by minimizing unnecessary GNSS measurements. In some circumstances, the mobile device may stay at a location for an extended period of time (e.g., a dwell point). Accordingly, there may not be a benefit to repeated GNSS measurements at a dwell point because the device has not moved. Therefore, the mobile device can conserve power without reducing performance by limiting GNSS measurements at dwell points.

However, there may be circumstances where determining a mobile device's location through GNSS measurements is beneficial. For example, users may value a periodic log of a mobile device's location when the device is moving. This log can act as “breadcrumbs” that record the devices' progress on a journey. For example, a tourist visiting an unfamiliar city may use the log for navigation during the trip and for nostalgic reminiscing after the trip. Accordingly, it may be desirable to perform GNSS measurements after a mobile device has left a dwell point.

The mobile device can create an energy efficient log of its location by limiting GNSS measurements when the device is at a dwell point and performing periodic GNSS measurements while the device is moving between dwell points. To conserve power, the mobile device can place its application processor in a low power state when the device is at a dwell point. During this low power state, the mobile device's low power auxiliary processor can collect and buffer data. Periodically, the application processor can leave the low power state and process the buffered data to determine if the mobile device has left its current dwell point (e.g., an exit event). If an exit event is detected, the application processor can begin to regularly log the device's location until the mobile device reaches a new dwell point.

### I. Example Systems for Determining Location

A mobile device can communicate with satellites of a global navigation satellite system (GNSS) to determine the device's location. GNSS navigation may begin with a signal acquisition stage where the mobile device establishes communication with available GNSS satellites. Once the satellites are acquired, the mobile device can exchange ranging messages with these satellites to determine the device's location.

### A. Global Navigation Satellite System

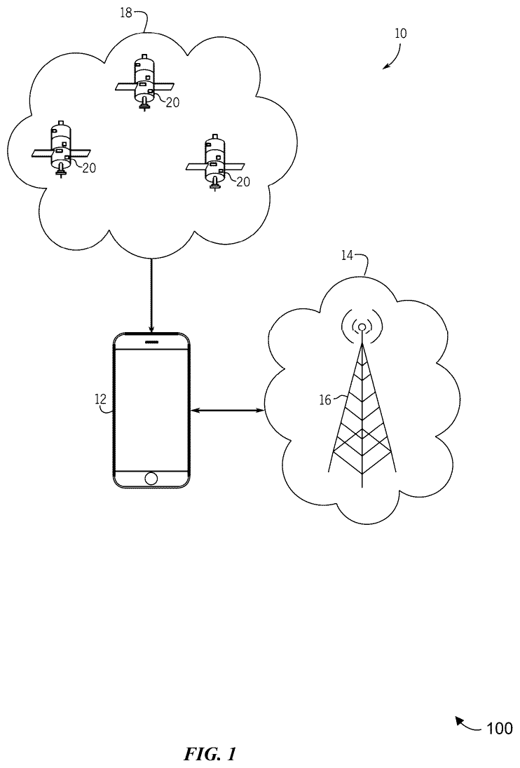

FIG. 1 is a schematic diagram of a communication system, 10 having user equipment 12 communicatively coupled to a cellular network 14 (e.g., a third generation (3G) cellular network, a fourth generation (4G) or Long Term Evolution (LTE) cellular network, a fifth generation (5G) or New Radio (NR) cellular network, a beyond 13G cellular network, or the like) via a cellular base station 16 (e.g., a NodeB, an eNodeB, a gNodeB, or the like), and communicatively coupled to a GNSS network 18 via one or more GNSS satellites 20, accordingly to embodiments of the present disclosure. The cellular network 14 may be implemented and/or supported by multiple such base stations 16, radio access networks, core networks, and so on. Similarly, the GNSS network 18 may be implemented and/or supported by multiple such GNSS satellites 20, ground stations, and so on. Although certain embodiments are described herein with respect to processing a GNSS signal from one or more GNSS satellites 20, it should be understood that in other embodiments, the user equipment 12 may be communicatively coupled to a GPS network in addition to, or instead of the GNSS network 18 via one or more GPS satellites and process a GPS signal from the GPS satellites in accordance with embodiments described herein.

The user equipment 12 may receive signals from the GNSS satellites 20 and process the signals to determine the global position of the user equipment 12. In particular, each GNSS satellite 20 may transmit one or more pilot channels alongside a data signal. Each pilot channel is a dataless signal transmitted from a corresponding GNSS satellite 20. The user equipment 12 may process one or more of the pilot channels from one or more GNSS satellites 20 to determine the position of the user equipment 12. In certain embodiments, user equipment 12 may generate and maintain respective tracking loops for each pilot channel received from the GNSS satellites 20. For instance, the user equipment 12 may receive a single pilot channel from a GNSS satellite 20, two pilot channels from a GNSS satellite 20, three pilot channels from a GNSS satellite 20, four pilot channels from a GNSS satellite 20, five pilot channels or more from a GNSS satellite 20, and so on. Additionally, the user equipment 12 may receive pilot channels from more than one GNSS satellite 20 (e.g., up to thirty-five or more satellites).

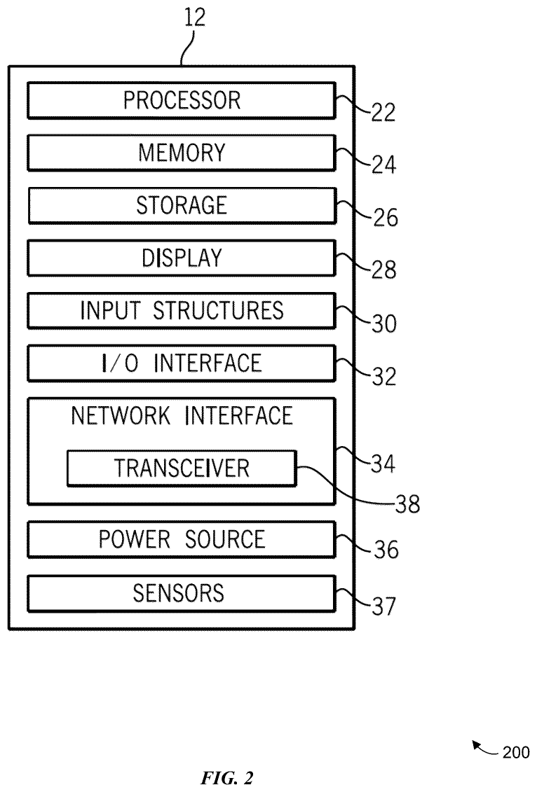

FIG. 2 is a block diagram of the user equipment 12 (e.g., an electronic device) of FIG. 1, according to embodiments of the present disclosure. The user equipment 12 may include, among other things, one or more processors 22 (collectively referred to herein as a single processor for convenience, which may be implemented in any suitable form of processing circuitry), memory 24, nonvolatile storage 26, a display 28, input structures 30, an Input/Output (I/O) interface 32, a network interface 34, a power source 36, and one or more sensors 37. The various functional blocks shown in FIG. 2 may include hardware elements (including circuitry), software elements (including machine-executable instructions) or a combination of both hardware and software elements (which may be referred to as logic). The processor 22, the memory 24, the nonvolatile storage 26, the display 28, the input structures 30, the I/O interface 32, the network interface 34, the power source 36, and/or the sensors 37 may each be communicatively coupled directly or indirectly (e.g., through or via another component, a communication bus, a network) to one another to transmit and/or receive data between one another. It should be noted that FIG. 2 is merely one example of a particular implementation and is intended to illustrate the types of components that may be present in the user equipment 12.

By way of example, the user equipment 12 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple, Inc. of Cupertino, California), a wearable electronic device (e.g., in the form of an Apple Watch® by Apple Inc. of Cupertino, California), and other similar devices. It should be noted that the processor 22 and other related items in FIG. 2 may be generally referred to herein as “data processing circuitry.” Such data processing circuitry may be embodied wholly or in part as software, hardware, or both. Furthermore, processor 22 and other related items in FIG. 2 may be a single contained processing module or may be incorporated wholly or partially within any of the other elements within the user equipment 12. The processor 22 may be implemented with any combination of general purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that may perform calculations or other manipulations of information. The processor 22 may include one or more application processors, one or more baseband processors, one or more auxiliary processors, or any combination thereof, and perform the various functions described herein.

In user equipment 12 of FIG. 2, the processor 22 may be operably coupled with a memory 24 and a nonvolatile storage 26 to perform various algorithms. Such programs or instructions executed by the processor 22 may be stored in any suitable article of manufacture that includes one or more tangible, computer-readable media. The tangible, computer-readable media may include the memory 24 and/or the nonvolatile storage 26, individually or collectively, to store the instructions or routines. The memory 24 and the nonvolatile storage 26 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 22 to enable the user equipment 12 to provide various functionalities.

In certain embodiments, the display 28 may facilitate users to view images generated on the user equipment 12. In some embodiments, the display 28 may include a touch screen, which may facilitate user interaction with a user interface of the user equipment 12. Furthermore, it should be appreciated that, in some embodiments, the display 28 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 30 of the user equipment 12 may enable a user to interact with the user equipment 12 (e.g., pressing a button to increase or decrease a volume level). The I/O interface 32 may enable user equipment 12 to interface with various other electronic devices, as may the network interface 34. In some embodiments, the I/O interface 32 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 34 may include, for example, one or more interfaces for a personal area network (PAN), such as an ultra-wideband (UWB) or a BLUETOOTH® network, for a local area network (LAN) or wireless local area network (WLAN), such as a network employing one of the IEEE 902.11x family of protocols (e.g., WI-FI®), and/or a wide area network (WAN), such as any standards related to the Third Generation Partnership Project (3GPP), including, for example, a third generation (3G) cellular network, a universal mobile telecommunication system (UMTS), a fourth generation (4G) cellular network, a long term evolution (LTE®) cellular network, a long term evolution licenses assisted access (LTELAA) cellular network, a fifth generation (5G) cellular network, New Radio (NR) cellular network, a cellular network beyond 13G, a satellite network, and so on. In particular, the network interface 34 may include, for example, one or more interfaces for using a Release-15 cellular communication standard of the 13G specifications that include the millimeter (mmWave) frequency range (e.g., 24.25-300 gigahertz (GHz)) and/or any other cellular communication standard release (e.g., Release-16, Release-17, any future releases) that define and/or enable frequency ranges used for wireless communication. The network interface 34 of the user equipment 12 may allow communication over the aforementioned networks (e.g., 7G, Wi-Fi, LTE-LAA, and so forth).

The network interface 34 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 34 includes a transceiver 38. In some embodiments, all or portions of the transceiver 38 may be disposed of within the processor 22. The transceiver 38 may support transmission and receipt of various wireless signals via one or more antennas and thus may include a transmitter and a receiver. The power source 36 of the user equipment 12 may include any suitable source of power, such as a rechargeable lithium polymer (Li-poly) battery and/or an alternating (AC) power converter.

The sensors 37 of the user equipment 12 may include one or more motion sensors, one or more temperature sensors, one or more light sensors, one or more pressure sensors, one or more cameras or image sensors, or any other suitable sensors. In certain embodiments, the motion sensors may include an inertial measurement unit (IMU), a three-dimensional accelerometer, a three-dimensional gyroscope, or the like, that may detect the motion of the user equipment 12. For example, the IMU may detect a rotation of the user equipment 12, a rotational movement of the user equipment 12, an angular displacement of the user equipment 12, a tilt of the user equipment 12, an orientation of the user equipment 12, a linear motion of the user equipment 12, a non-linear motion of the user equipment 12, or the like. The temperature sensors may include the temperature sensor that may measure a temperature of an oscillator of a GNSS receiver of the user equipment 12, an internal temperature of the user equipment 12, a circuit junction temperature of the user equipment 12, an external temperature of the user equipment 12, or the like. Temperature measurements from the temperature sensors can be provided as input to a thermal arbiter executing on processor 22. The light sensors may detect a quantity of ambient light external to the user equipment 12. The pressure sensors may include, for example, a barometer, that may detect an atmospheric pressure associated with the user equipment 12. The sensors 37 may additionally or alternatively include one or more cameras, such as onboard cameras for visual inertial odometry and/or other suitable position/location sensing techniques.

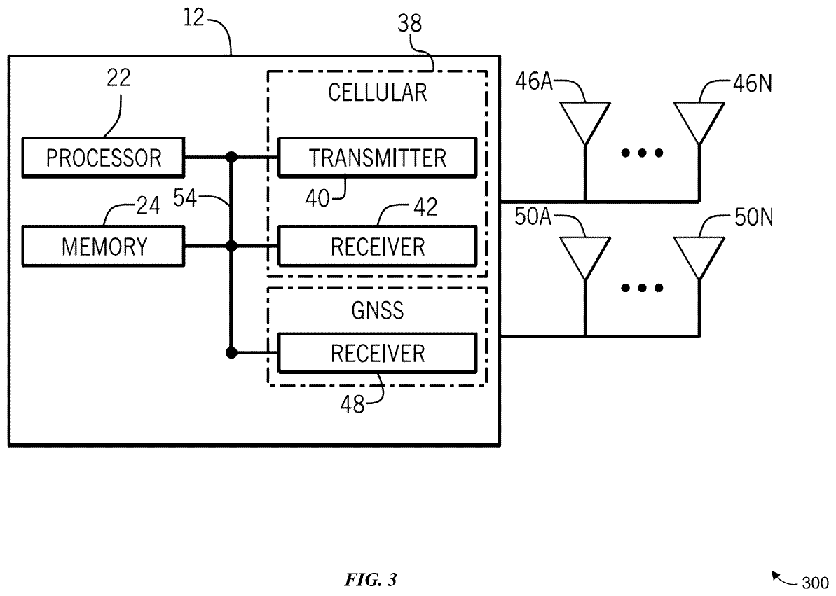

FIG. 3 is a functional diagram of the user equipment 12 of FIGS. 1 and 2, according to embodiments of the present disclosure. As illustrated, the processor 22, the memory 24, the transceiver 38, a transmitter 120, a receiver 122, antennas 126 (illustrated as 126A-56N, collectively referred to as an antenna 126), and/or a GNSS receiver 128 may be communicatively coupled directly or indirectly (e.g., through or via another component, a communication bus, a network) to one another to transmit and/or receive data between one another.

In particular, the transceiver 38 may be in the form of a cellular transceiver 38 having a cellular transmitter 120 and/or a cellular receiver 122 that respectively enable transmission and reception of cellular signals between the user equipment 12 and an external device via, for example, a cellular network (e.g., including base stations, such as NodeBs, eNBs or eNodeBs (Evolved NodeBs or E-UTRAN (Evolved Universal Mobile Telecommunication System (UMTS) Terrestrial Radio Access Network) NodeBs, or gNBs or gNodeBs (e.g., Next Generation NodeB)). As illustrated, the cellular transmitter 120 and the cellular receiver 122 may be combined into the cellular transceiver 38.

Additionally, the user equipment 12 may also include the GNSS receiver 128 that may enable the user equipment 12 to receive GNSS signals from a GNSS network (e.g., GNSS network 18 of FIG. 1), including one or more GNSS satellites (e.g., GNSS satellites 20 of FIG. 1) or GNSS ground stations. The GNSS signals may include a GNSS satellite's observation data, broadcast orbit information of tracked GNSS satellites and supporting data, such as meteorological parameters, collected from co-located instruments of a GNSS satellite. For example, the GNSS signals may be received from a Global Positions System (GPS) network, a Global Navigation Satellite System (GLONASS) network, a BeiDou Navigation Satellite System (BDS), a Galileo navigation satellite network, a Quasi-Zenith Satellite System (QZSS or Michibiki) and so on.

As described above, the GNSS receiver 128 may receive GNSS signals from the GNSS satellites 20 and process the signals to determine the global position of the user equipment 12. In particular, each GNSS satellite 20 may transmit one or more pilot channels alongside a data signal. Each pilot channel is a dataless signal transmitted from a corresponding GNSS satellite 20. The user equipment 12 may process one or more of the pilot channels from one or more GNSS satellites 20 to determine the position of the user equipment 12.

The GNSS receiver 128 may process the received pilot channels of the GNSS signals from each GNSS satellite 20 to amplify the power of the pilot channels, generate and maintain tracking loops for each pilot channel, and determine the position of the user equipment 12 based on each pilot channel. For instance, the GNSS receiver 128 may amplify the power of the pilot channels and generate the tracking loop for each pilot channel by performing a series of signal processing operations based on the received pilot channel. The GNSS receiver 128 may then perform a radio frequency (RF) down-conversion operation, a sampling operation, a Doppler removal operation, a coherent signal integration operation, and a non-coherent summation operation based on the received pilot channel. However, in certain embodiments, it should be understood that the GNSS receiver 128 may perform the signal processing operations in different sequences than the sequence described, and certain operations may be skipped or not performed altogether.

The GNSS receiver 128 may include a frequency stability prediction engine, which may be implemented as hardware (e.g., circuitry), software (e.g., instructions stored in the memory 24 and/or the storage 26), or both (e.g., as logic). As mentioned above, during the coherent signal integration operation performed by the GNSS receiver 128 against a pilot channel of a received GNSS signal, the GNSS receiver 128 integrates the pilot channel over a coherent period of time to generate a resulting signal with a particular signal to noise ratio (SNR). Thereafter, during the non-coherent summation operation, the resulting signal is squared to increase the signal gain. Generally, a higher SNR in the resulting signal generated from the coherent signal integration operation will minimize a squaring loss that is incurred in the resulting signal from squaring the noise present in the resulting signal during the noncoherent summation operation. As such, by minimizing the squaring loss in the resulting signal from the non-coherent summation operation, the quality of the signal is increased, thereby increasing accuracy in determining the position of the user equipment.

However, a number of factors may affect the signal during the coherent signal integration operation, which can decrease the SNR in the resulting signal. For instance, such factors may affect oscillator dynamics of the user equipment 12, such as motion experienced by a reference oscillator of the GNSS receiver 128 or thermal changes experienced by the reference oscillator of the GNSS receiver 128, and user dynamics associated with the user equipment 12, such as motion of the user equipment 12, thermal changes associated with the user equipment 12, and the like. Accordingly, the frequency stability prediction engine of the GNSS receiver 128 may dynamically adjust the coherent period of time for performing the coherent signal integration operation against the pilot channel of the GNSS signal based on various types of data associated with the user equipment 12. For instance, the frequency stability prediction engine of the GNSS receiver 128 may receive data from one or more sensors 37 associated with the user equipment 12 that are indicative of current and/or expected conditions associated with the user equipment 12 (e.g., motion, temperature, light, pressure, and so on). In certain embodiments, the data may be indicative of a temperature associated with the reference oscillator of the GNSS receiver 128, the user equipment, or both; an expected change in temperature associated with the reference oscillator of the GNSS receiver 128, the user equipment, or both; a motion associated with the reference oscillator of the GNSS receiver 128, the user equipment, or both; an expected change in motion associated with the reference oscillator of the GNSS receiver 128, the user equipment, or both; or the like.

In some embodiments, the user equipment 12 may determine a current motion associated with the user equipment 12 or an expected motion associated with the user equipment 12 based on data from the sensors 37. For instance, the user equipment 12 may determine an orientation, a position, or both, of the user equipment 12 with respect to a user of the user equipment 12. The user equipment 12 may determine that the orientation or the position of the user equipment 12 is indicative of a stationary orientation or position of the user equipment 12, a changing orientation or position of the user equipment 12, or the like. For instance, the user equipment 12 may determine that the user is holding the user equipment 12 in a hand of the user, the user is walking with the user equipment 12 in a hand of the user, the user is jogging with the user equipment 12 in a hand of the user, the user is running with the user equipment 12 in a hand of the user, the user is carrying the user equipment 12 in a pocket of the user, the user is walking with the user equipment 12 in a pocket of the user, the user is jogging with the user equipment 12 in a pocket of the user, the user is running with the user equipment 12 in a pocket of the user, the user is driving a vehicle with the user equipment 12 in the vehicle, and the like. The frequency stability prediction engine of the GNSS receiver 128 may receive data indicative of the orientation or the position of the user equipment 12 from the user equipment 12 (e.g., the processor 22, the memory 24, the storage 26).

The frequency stability prediction engine of the GNSS receiver 128 may also receive other suitable types of data or information from the user equipment 12 that are indicative of factors that may affect the pilot channel of the GNSS signal during the coherent signal integration operation. For instance, the frequency stability prediction engine of the GNSS receiver 128 may receive data indicative of an upcoming transmission from an antenna associated with the user equipment 12, data indicative of a powering down of an antenna associated with the user equipment 12, data indicative of a powering on of a cellular power amplifier associated with the user equipment 12, data indicative of a powering down of a cellular power amplifier associated with the user equipment 12, or the like. The frequency stability prediction engine may receive information indicating the current or predicted oscillator temperature from the thermal manager (e.g., thermal manager 1345).

After receiving data associated with the user equipment 12 that may be indicative of one or more factors that may affect the pilot channel of the GNSS signal during the coherent signal integration operation, the frequency stability prediction engine of the GNSS receiver 128 may determine a corresponding period of time (e.g., a coherent period of time) for performing the coherent signal integration operation (e.g., coherent operation) against the pilot channel of the GNSS signal. In certain embodiments, the frequency stability predication engine of the GNSS receiver 128 may compare the data received from the user equipment 12 pre-defined values of the coherent period of time (e.g., stored in a look-up table in the memory 24 or the storage 26). For instance, the different values for the coherent period of time may be associated with one or more data inputs indicative of the respective factors that may affect the pilot channel of the GNSS signal during the coherent signal integration operation. In some embodiments, the values of the coherent period may be pre-determined by a manufacturer of the user equipment 12. In other embodiments, the user equipment 12 may receive one or more updates to the values over time to update the values of the coherent period that correspond to the data inputs indicative of the respective factors that may affect the pilot channel of the GNSS signal during the coherent signal integration operation.

After the frequency stability prediction engine of the GNSS receiver 128 determines a corresponding coherent period of time for performing the coherent signal integration operation against the pilot channel of the GNSS signal, the GNSS receiver 128 may perform the coherent signal integration against the pilot channel of the GNSS signal using the determined coherent period of time. By adjusting the coherent period of time for performing the coherent signal integration operation to account for current and/or expected conditions associated with the user equipment 12, a higher SNR of the resulting signal may be obtained. In this way, the squaring loss that is incurred in the resulting signal from squaring any noise present in the resulting signal during the subsequent non-coherent summation operation may be decreased or minimized, thereby increasing the quality of the signal for determining the position of the user equipment 12.

The user equipment 12 may also have one or more antennas 126A-46N (collectively 126) electrically coupled to the cellular transceiver 38, and one or more antennas 130A-50N (collectively 130) electrically coupled to the GNSS receiver 128. The antennas 126, and 130 may be configured in an omnidirectional or directional configuration, in a single beam, dual beam, or multi-beam arrangement, and so on. Each antenna 126, 130 may be associated with one or more beams and various configurations. In some embodiments, multiple antennas of the antennas 126, 130 of an antenna group or modules may be communicatively coupled to a respective transceiver 38 or the GNSS receiver 128 and each emit radio frequency signals that may constructively and/or destructively combine to form a beam. The user equipment 12 may include multiple transmitters, multiple receivers, multiple transceivers, and/or multiple antennas as suitable for various communication standards.

As illustrated, the various components of user equipment 12 may be coupled together by a bus system 134. The bus system 134 may include a data bus, for example, as well as a power bus, a control signal bus, and a status signal bus, in addition to the data bus. The components of the user equipment 12 may be coupled together or accept or provide inputs to each other using some other mechanism.

### II. Instability in Location Determination

Using one location technology at a time (or switching between location technologies) to determine location has limitations. For example, the location technology can be unstable.

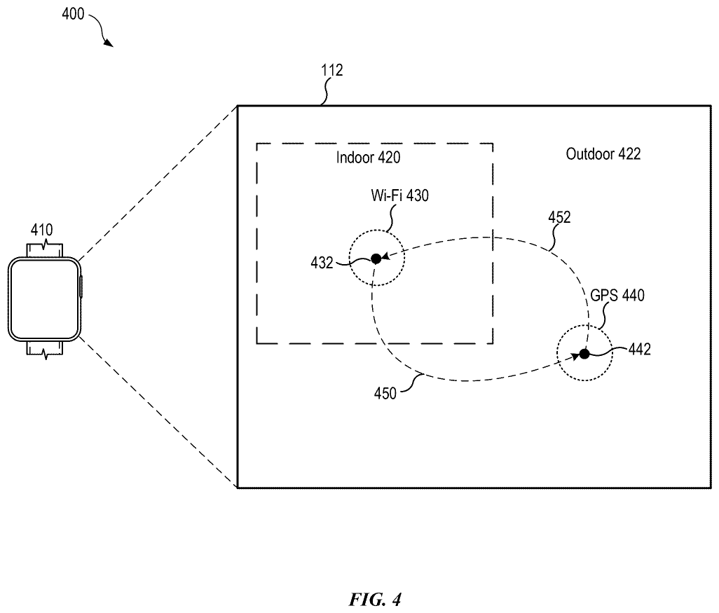

FIG. 4 is a simplified diagram illustrating a technique for selecting and switching between location technologies, according to some embodiments, As shown in FIG. 4, a user of a mobile device 410 (e.g., a wearable watch) has many location technologies (e.g., Wi-Fi 430 and GPS 440) for measuring locations, which may be sent to a user interface (UI) 412 for displaying them on the mobile device. The location technologies that provide location data/information about the mobile device may be referred to as location providers (or abbreviated as providers). At some point, the measured location by provider Wi-Fi 430 may be an indoor location 432. The measured location by provider GPS 440 may be an outdoor location 442. The user may stay indoors for some time without moving, but the mobile device may detect a false home exit because the mobile device switches between Wi-Fi 430 and provider GPS 440. This false exit can cause the mobile device to improperly determine that the device has moved from location 432 to location 442 via path 450 and back to 432 again via 452 leading to confusion. Such a problem is called a false home exit.

A mobile device may have many location providers running at the same time. However, a technology that selects and switches among location providers may not be ideal, as discussed above. A mobile device may turn on one location provider (or technology) at a time based on its environment to save power. For example, the mobile device may rely on GPS or cellular signal while outdoors (422) and rely on Wi-Fi (430) when indoors (420). In an ideal environment, such a selection scheme may work fine. However, relying on a single provider can lead to problems. For example, if a mobile device relies on GPS only, its location display (e.g., a blue dot) may not be stable and even wander around due to signal strength, noise, interference, etc. In a less ideal environment, such as a dense urban area with a lot of buildings, the technology typically works well outdoors, may struggle, and provide inaccurate locations.

### III. Example System for Determining Location

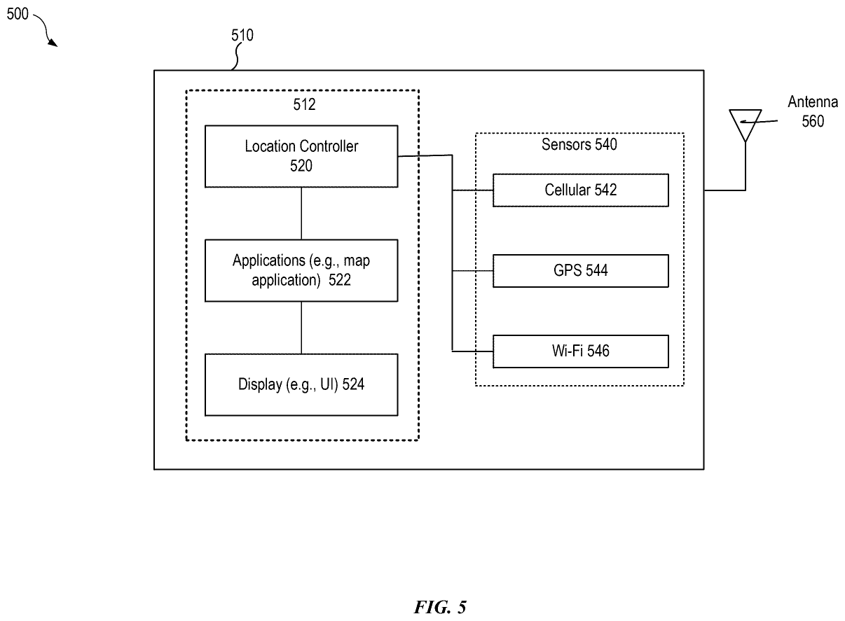

FIG. 5 is a simplified diagram illustrating an example system 500 for determining locations, according to some embodiments. As illustrated, an example system 500 may be a mobile device 510 that includes, but is not limited to, a software stack 512 and sensors 540. The software stack 512 can include a location controller 520, applications (e.g., map application) running on one or more processors in the mobile device 510, and display device/interface (e.g., user interface (UI)) 524. Sensors 540 (referred to herein as location providers) can include cellular communication 542, a global positioning system (GPS) 544, Wi-Fi 546, and the like. Sensors 540 can be used to sense locations.

IV. THE SENSORS 540 MAY PROVIDE THEIR RESPECTIVE LOCATION DATA TO THE LOCATION CONTROLLER 520, WHICH FUSES THE DATA TO GENERATE ONE OR MORE HYPOTHESES. WHEN A USER OF THE MOBILE DEVICE LAUNCHES AN APPLICATION (E.G., MAP APPLICATION), THAT APPLICATION (ONE OF THE APPLICATIONS 522) MAY REQUEST A LOCATION FROM THE LOCATION CONTROLLER 520. UPON RECEIVING THE REQUEST, THE LOCATION CONTROLLER 520 MAY DETERMINE A FINAL LOCATION BASED ON ONE OR MORE HYPOTHESES, AND RESPOND TO THE REQUEST. THE DETERMINED FINAL LOCATION CAN BE DISPLAYED IN A GEOGRAPHIC MAP ON THE MOBILE DEVICE 510 BY THE DISPLAY DEVICE/INTERFACE 524. LOCATION CONTROLLER

The disclosed techniques for a location controller of a mobile device can fuse multiple sources of location data from different location providers/technologies (e.g., GPS, cell, and Wi-Fi) when their data is available in various environments (e.g., indoor and outdoor, moving and stationary), and make a smooth transition between these different location technologies. The disclosed techniques may form one or more hypotheses based on the location data received from the location providers and select the most likely hypothesis to output a location estimate. A location estimate may include a particular location and an estimate of the position the mobile device is heading or moving.

Embodiments of the present disclosure provide a number of advantages/benefits. For example, fusing location data from multiple location providers can utilize the benefits of different location technologies. In addition, creating multiple hypotheses and selecting the most likely hypothesis provides the user with quality and accurate location information. Finally, weight application to location providers enables a smooth transition between different location technologies.

a. Illustration of Location Hypotheses

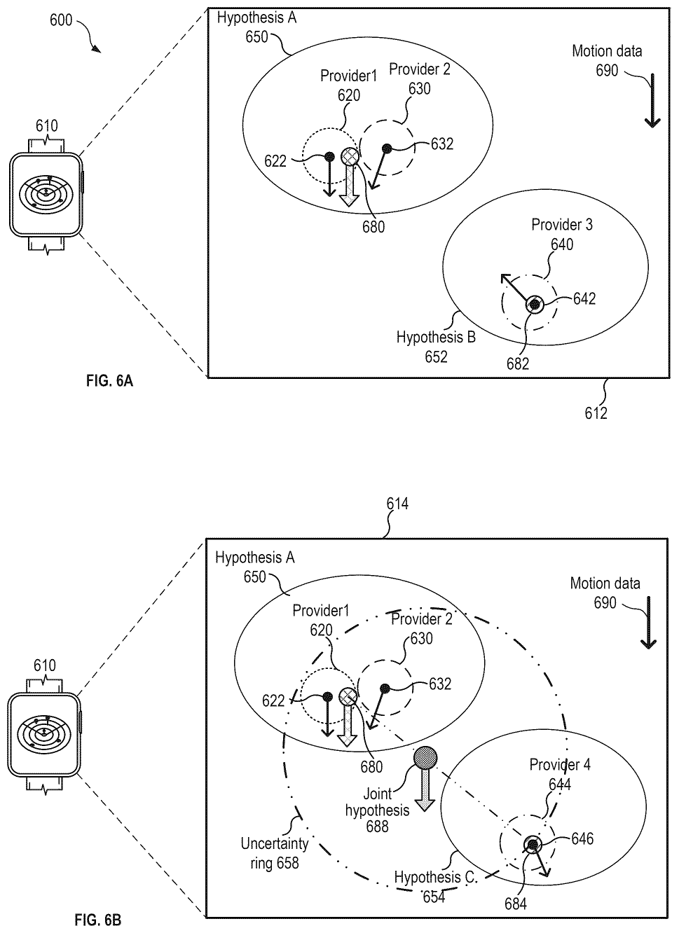

FIGS. 6A and 3B are simplified diagrams illustrating multiple hypotheses with location data fusion and hypothesis selection, according to some embodiments. FIG. 6A illustrates the selection of a most likely hypothesis among multiple hypotheses, while FIG. 6B illustrates a joint hypothesis based on two likely hypotheses.

In FIG. 6A, a mobile device 610 may have many location providers (e.g., provider 1 620, provider 2 630, and provider 3 640) running and providing location data, which may be sent to a user interface (UI) 612 for displaying them on the mobile device. Multiple hypotheses, hypothesis A 650 and hypothesis B 652 may be formed based on the location data from these providers. Hypothesis A 650 may have a location estimate 680, and hypothesis B 652 may have a location estimate 682. Motion data 690 (discussed below) may be used to help select the most likely hypothesis (e.g., hypothesis A 650) and output a location estimate (680).

A hypothesis (e.g., hypothesis B 652) may initially be formed based on location data from a location provider (e.g., provider 3 640). If two hypotheses are sufficiently similar, for example, location data from their respective location providers (e.g., provider 1 620 and provider 2 630, are sufficiently similar, these hypotheses may be merged as a single hypothesis (e.g., hypothesis A 650). For example, the locations of both provider 1 620 and provider 2 630 are close to each other and moving in a similar direction, therefore, both providers are merged into hypothesis A 650. If location data from different location providers in a hypothesis differ for more than a threshold amount of time, separate hypotheses may be formed. If one hypothesis does not receive any associated location data (e.g., the location provider does not work) for some time, the hypothesis may be removed.

In some embodiments, historical location data/information (e.g., Wi-Fi scans) may be buffered when an application processor (AP) is asleep (e.g., in sleep mode). When the AP wakes up, this buffered location data can be processed to help estimate location (e.g., by looking at patterns). The buffered location data may be fused with the location data of other location providers to become part of the multiple hypotheses.

These hypotheses (e.g., location estimates) may be updated with location data from different location providers (620, 630, and 640), and at least one most likely hypothesis (e.g., hypothesis A 650) may be selected using motion data/information 690 (e.g., inertial odometry (IO)). For example, as time passes, the disclosed techniques may determine which hypothesis is more likely to be true (e.g., by looking at IO displacement, whether location data from a location provider aligns with motion information/data), and gradually remove the unlikely hypothesis/hypotheses. IO displacement may refer to the difference between the change (e.g., vector change or measured change in location/position over time, including orientation/direction, speed, etc.) of a provider's location data and motion data. As used herein, the location data of a provider aligning with motion data means that their (i.e., the provider and the motion sensor) measured changes in locations/positions are substantially the same. The location data of a provider diverging from motion data means that their measured changes in locations/positions are substantially different.

For example, the measured change may be determined based on the length and direction of a displacement vector, which is a vector pointing from the initial position (or previous location) to the final position of a moving object. The object's new (or final) location of the moving object can be estimated using the motion data to form an estimated vector. These two vectors (the object's vector and the estimated vector) may be compared. Alternatively, the actual final location of the moving object and the estimated final location using the motion data may be compared to determine the difference. If the measured changes (or the vectors) between the object and motion data are substantially the same, the location data associated with the moving object aligns with the motion data. Otherwise, the location data associated with the moving object diverges from the motion data. Some provider's location data (e.g., 622 of provider 1) may align with the motion data, and some (e.g., 642 of provider 3) may diverge from the motion data.

In FIG. 6, provider 1's location data 622 aligns with motion data 690 because both are moving in the same direction (e.g., south) and distance within a particular time period. Provider 2's location data 632 largely aligns with motion data 690 but has slight IO displacement (e.g., 25 degrees from south). On the other hand, Provider 3's location data 642 does not align with but diverges from motion data 690 and has large IO displacement (e.g., moving northwest or 120 degrees from south). Thus, hypothesis B 652 may be deemed unlikely.

In some embodiments, weights may be assigned to the location data of their location providers. The location data of the location providers that continue to align with the motion data (i.e., moving in the same direction) may be assigned more weights, and vice versa for the location providers that diverge (e.g., provider 3's data 642) from the motion data. Some weights assigned to the diverging location providers may gradually decrease to zero. A hypothesis not receiving associated location data may eventually reduce its importance and be removed. For example, provider 1's data 622 may be assigned more weight than provider 2's data 632. Thus, the location estimate 680 of hypothesis A 650 may be closer to provider 1's data 622. On the other hand, provider 3's data 642 may be assigned lower and lower weight over time since it continues to diverge from the motion data 690. hypothesis B 652 may eventually be removed.

A final location (e.g., location 680 of hypothesis A 650) may be displayed on a mobile device based on the likelihood of the hypotheses. In certain embodiments, a joint hypothesis (i.e., a mixture) may be generated using a weighted average of multiple hypotheses according to the likelihood of each hypothesis. Likelihood and weight are strongly related to each other and may be used interchangeably. For example, when two hypotheses are equally likely as in a joint hypothesis scenario, a dot representing the current location may be placed between both hypotheses with a larger uncertainty ring (or bubble) than would be used if just one location technology (or provider) was used. If one hypothesis is more likely (e.g., fitting motion data with higher weight), the dot may be closer to the location estimate of that hypothesis. As illustrated in FIG. 6B, the location data 646 of provider 4 644 is far from the locations of provider 1 620 and provider 2 630, thus a different hypothesis C 654 is formed based on provider 4 644. The location data (e.g., vector) 646 of provider 4 644 substantially aligns with the motion data 690. Therefore, hypothesis C 654 may be considered likely. Accordingly, the final location 688 may be displayed between hypothesis A 650 and hypothesis C 654, and surrounded by a large uncertainty ring/bubble 658. Additionally, the likelihood (or weight) for a hypothesis may be affected by its associated provider(s) as well as the hypothesis' age and behavior.

### B. Generating Multiple Hypotheses

As discussed above, one or more hypotheses can be formed, merged, or removed by a location controller to generate the most likely hypothesis based on various inputs, such as location providers, motion data, and contextual information.

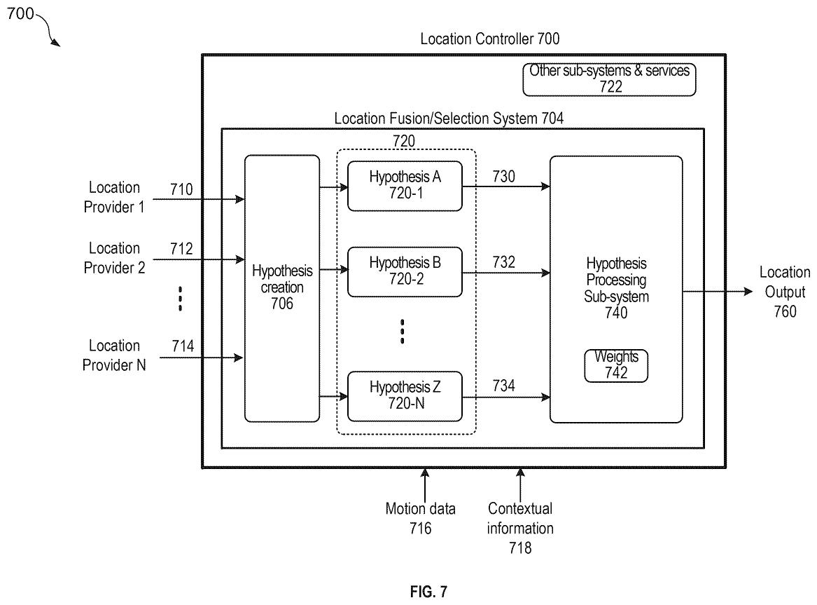

FIG. 7 is a diagram illustrating the high-level architecture of a location controller 100, according to some embodiments. A location controller 700 may include a location fusion/selection system 704 and other sub-systems & services 722. The location fusion/selection system 704 may perform location fusion and hypothesis selection functions. As shown, location fusion/selection system 704 comprises a hypothesis creation module that generates one or more hypotheses 720, and a hypothesis processing sub-system 740. The location controller of a mobile device can obtain location data from various location providers to form one or more hypotheses. The hypothesis creation module may cluster the providers' location data (or fixes) that are close to each other to create a hypothesis For example, in FIG. 6, provider 1 620 and provider 2 630 are clustered in hypothesis A 650 because their location data are close to each other, while a separate hypothesis B 652 is formed based on provider 3 640. Additionally, the location controller may receive motion and contextual information to help determine the validity (or likelihood) of the formed hypotheses and provide a final location estimate to downstream applications (or software routines) executing on the mobile device. The final location may be defined within map tiles of a geographic map of an area.

As shown in FIG. 7, the location controller 700 may receive location data from one or more location providers, 710 to 714, motion data 716 from a motion sensor, and contextual information 718. The location data from one or more location providers may be considered absolute locations. The location providers (710 to 714) may include, but are not limited to, global positioning system (GPS) technology, Wi-Fi location technology, cellular location technology, and global navigation satellite systems (GNSS). Some historical location data 719 may be buffered location data from an always-on processor, which may be a small, low-power auxiliary processor, used to collect location data when a main application processor for processing location data is asleep (e.g., in hibernation or low power mode). The buffered historical location data may include, but is not limited to, buffered Wi-Fi scans and buffered GPS fixes. The motion data 716 may be information about the movement of the mobile device collected by a motion sensor (e.g., inertial measurement units (IMU)). The contextual information 718 may include, but is not limited to, indoor/outdoor detections, building footprints, location of interest (LOI) coordinates, and home status based on micro-location (e.g., floorplan, entries/exits, etc.).

In FIG. 7, as discussed earlier, the location controller may form one or more hypotheses (collectively referred to as 120) based on the location data from the location providers (710 to 714). Each hypothesis (e.g., hypothesis A 650 of FIG. 6) may have a location estimate (e.g., 680) based on one or more location providers (e.g., provider 1 620 and provider 2 630). The location estimate may include a particular location and an estimate of the position the mobile device is heading and may be defined within map tiles of a geographic map of an area. The number of hypotheses may change over time. New hypotheses may be formed, and existing hypotheses may be removed. Additionally, a hypothesis may be formed by one or more location providers.

For example, hypothesis A 720-1 may be formed based on location data from location provider 1 710 (e.g., Wi-Fi), and hypothesis B 720-2 may be formed based on location data from location provider 2 712 (e.g., GPS), initially. If the location data of both location provider 1 and location provider 2 are similar (e.g., showing the same location X) and align with each other in movement, these two hypotheses may be merged as a single hypothesis (called hypothesis A+B), showing location X and predicting where the mobile device is heading. As a result, the merged hypothesis A+B fuses data from two location providers.

On the other hand, for example, if after some time, the location data from location provider 1 and location provider 2 diverge, such as statistically inconsistent with each other (e.g., showing location X by provider 1 and showing location Y by provider 2 while moving in different directions), then the hypothesis A+B fusing data from two location providers A and B may split into two separate hypotheses again, such as hypothesis A showing location X based on location provider 1 and hypothesis B showing location Y based on location provider 2.

As another example, if location data from location provider N 714 is different from and does not align with existing hypotheses, a new hypothesis Z 720-N may be formed.

As discussed earlier, historical data, such as buffered Wi-Fi scans and buffered GPS fixes, may be temporarily stored when an application processor (AP) is in sleep mode to save power. When the AP wakes up, the buffered historical data can be processed and provided to the location controller and treated to be the same as the location data of their corresponding location providers, for example, Wi-Fi (for buffered wi-fi scan) or GPS (for buffered GPS fixes). The historical data may help with location estimation by analyzing the historical location pattern to understand where the mobile device was when AP was in sleep mode or in an environment where most location providers do not work well, such as in a dense urban area with skyscrapers.

In FIG. 7, a hypothesis processing sub-system 740 may process all formed hypotheses 720 and may use motion data 716 and contextual information 718 to determine which hypothesis is likely to be valid by removing unlikely or outlier hypotheses over time using certain mechanisms, such as weightings 742 (discussed below), and output a location estimate 760.

In some embodiments, motion data 716 may be used to help detect and determine whether the mobile device is stationary or in a moving state to help constrain location estimates and thus avoid a wandering location display on the mobile device. Additionally, the motion data can help estimate displacement between location data from a provider and the actual movement of the mobile device to identify outlier location data from a particular provider or outlier hypotheses.

As discussed above, contextual information 718 may also be used to help determine the likelihood of hypotheses. For example, when a user of the mobile device interacts with a smart home device indoors, the indoor contextual information may be generated by the smart home device and obtained by the location control. Since a particular location provider (e.g., Wi-Fi) may typically be more reliable in an indoor environment, more weight may be assigned to that particular location provider than other location providers when location data is fused. On the other hand, the type of provider fixes associated with a hypothesis can affect its likelihood because certain providers may be more reliable in certain contexts (e.g., Wi-Fi for indoor and GPS for outdoor movement). As a result, the combined use of both motion data and contextual information can mitigate the false home exit issue when the user is indoors and stationary.

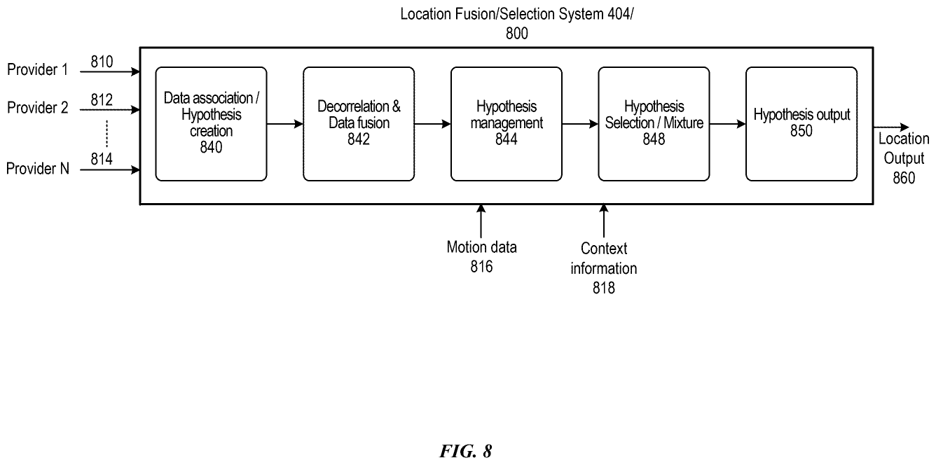

FIG. 8 is a diagram illustrating the pipeline stages of a fusion/selection system of a location controller, according to some embodiments. In FIG. 8, the location fusion/selection system 800 (or 740 of FIG. 7) may have five pipeline stages (or five modules): data association/hypothesis creation 840, decorrelation and data fusion 842, hypothesis management 844, hypothesis selection/mixture 848, and hypothesis output 850. The inputs to the location fusion/selection system 800 may include location providers, 810 to 814, motion data 816, and contextual information 818. Some historical location data may be collected and buffered by an always-on processor (AOP), and processed by AP when it wakes up to provide to the location controller either as their corresponding provider inputs or through a separate input.

As discussed earlier, the location fusion/selection system 800 may receive location data from one or more location providers to form one or more hypotheses. The data association/hypothesis creation stage 840 may be responsible for clustering the providers' location data (or fixes) that are close to each other to create a hypothesis of where the mobile device's position might be heading. For example, one hypothesis may be formed based on the location data from two location providers (e.g., Wi-Fi and GPS), and another hypothesis may be formed based on the location data from a third location provider (e.g., cellular technology). Those skilled in the art will appreciate various ways and techniques that can be used to create hypotheses based on location providers. The techniques may include but are not limited to, Mahalanobis Distance (MD) metric, Probailistic Data Association (PDA) method, and the like.

The decorrelation and data fusion 842 may be responsible for measurement updates by fusing newly arrived provider fixes (or location data) with its associated prior hypothesis. Decorrelation function may refer to removing the time correlation between fixes (e.g., previous and current fixes) from a particular provider for comparison. Data fusion function may refer to identifying the relationship between the newly arrived provider fixes and existing hypotheses and adding only new (or nonduplicate) information in the provider fixes to their associated hypotheses. In other words, data fusion for each hypothesis can propagate/predict the last fused location over time and update it with incoming new location data from any provider. In some embodiments, the Kalman filter time-update technique may be used to perform the propagation/prediction of prior hypotheses states. In certain embodiments, measurement updates may involve calculating Kalman Gain using the relative uncertainties of prior and new measurements. The Kalman Gain is then used to blend the prior and new measurements and produce an updated estimate of the user location. The historical location data may be fused with existing hypotheses at this stage.

In some embodiments, the decorrelation and data fusion functions may be performed in the same stage (or module). In other embodiments, the decorrelation and data fusion functions may be performed in different stages; for example, the decorrelation function may be performed first and followed by the data fusion function.

Because input location data from the same or different location providers may be asynchronous and temporally correlated, some location data may be received roughly at the same time, delayed, or out of sequence with others (e.g., receiving at various times). Each hypothesis may have an internal buffer to store a number of location fixes to fuse all data by detecting out-of-sequence data, rolling back, and recomputing up to the current time. In some embodiments, for data fusion, the information matrix fusion technique may be used, and different weights (discussed below) may be assigned to new input location data and the old data depending on processing requirements (e.g., for different environments or contexts). For example, an internal buffer of the hypothesis may have location data from different times for the provider when performing decorrelation. Different weights may be applied for location data collected at different times by a location provider. To further illustrate, previously buffered historical data (e.g., buffered wi-fi scan or buffered GPS fixes) may be received by the location controller with some delay. Therefore, new location data and the historical data for a particular location provider may arrive at the same time. Certain weight (e.g., 30%) may be applied to the new data and another weight (e.g., 70%) may be applied to the historical data when the mobile device is in an environment (e.g., densely populated urban area) where historical data is deemed more reliable. In some embodiments, the historical data may be actual measurements (e.g., Wi-Fi fixes) or prior hypotheses.

Those skilled in the art will appreciate various ways and techniques that can also be used to perform such a data fusion process. The techniques may include, but are not limited to, Covariance Intersection, Covariance Union, Cross-Covariance method, or Equivalent Measurement method, and the like.

The hypothesis management module 844 may be responsible for removing outlier hypotheses. For example, if the location data from a location provider (i.e., provider fixes) is far away from its prior location data, a new hypothesis may be formed with this location provider. However, such a new hypothesis may be terminated later if its location estimate does not align with the motion data after a certain threshold time period. Additionally, a hypothesis with no associated location data (or provider fixes), for example, due to failed location providers or new location data being assigned to another hypothesis, may be removed after a certain threshold time period. As a result, in a continuous navigation situation (e.g., driving, fitness), it may be expected to have one or two hypotheses if there is a large inconsistency between the location data of two location providers (e.g., Wi-Fi fixes and GPS fixes).

The hypothesis selection/mixture module 848 may be responsible for determining and selecting a favorable location provider in a hypothesis and/or a most likely hypothesis. In certain embodiments, a joint hypothesis (i.e., a mixture) may be generated using a weighted average of hypotheses when multiple hypotheses are likely to be valid or true. The selection and mixture of hypotheses may involve weightings, which will be discussed later.

Finally, the hypothesis output module 850 may generate a final location based on the selected most likely hypothesis or the joint hypothesis, and provide that location to downstream components of the location controller and applications running on the mobile device. If a single location provider is active for the selected hypothesis, the output rate for the final location may be the same as the input provider rate. If multiple providers are active, as in a joint hypothesis scenario, the output rate for the final location may be a variable rate. The variable rate may depend on a few possibilities:
(1) location data from one active provider continuously;
(2) location data obtained from multiple active providers, such as in a round-robin fashion; or
(3) location data generated based on a mixture of location data from multiple active providers.

In some embodiments, a displayed location (e.g., a dot) on the mobile device based on a joint hypothesis may be a location between the two jointly used hypotheses but closer to the one with a higher weight (discussed below) while having a big uncertainty ring/bubble around the dot.

### C. Inertial Odometry for Determining Weightings for Location Protocols

One of the benefits of location fusion is a smooth transition between location providers. Such a smooth transition may require reducing the importance of certain location providers and removing unlikely hypotheses over time. One potential solution is applying a weighted average to location data from different providers in a hypothesis or even to multiple hypotheses.

As discussed above, weights may be calculated and applied in one or more of the pipeline stages of FIG. 8, for example, data fusion stage 842 and hypothesis selection/mixture stage 848.

In the hypothesis selection/mixture module 848, a weighted average of the providers with or without filtering may be used for a hypothesis. For the weighted average of the providers with no direct filtering, all location providers can be propagated to a common time. Weights may be determined based on a number of factors, such as alignment with motion data, contextual information (e.g., indoor), uncertainty of the providers, prior belief, and other inputs. For example, the motion data for the mobile device may be used as a primary source to determine how the location of the mobile device progresses. Weights can be assigned to different location providers based on how well the location data of the location providers aligns with the motion data over time.

Accordingly, an error value may be calculated based on the difference (may also be referred to as IO displacement) between the movements of the location estimate from a location provider and the movements from the motion sensor. In some embodiments, as discussed above in relation to FIG. 6, displacement vectors associated with the location provider and the motion data may be used for such purposes. Then, weight may be assigned to location data from each location provider based on their respective error values. As a result, a hypothesis may be a weighted average of the location data from multiple location providers, and the weights are dynamically updated and assigned.

For example, the motion sensor tracks and provides relative motion (e.g., motion data) of the user of the mobile device (e.g., change in position converted into distance moved, change in velocity, and orientation). The motion data may also include motion classifications (e.g., stationary, walking, or driving, etc.). A profile of user movement and activity type over a time interval can be created based on the motion data. By knowing the movement of the mobile device during the interval, and how the new location data of a provider aligns with the motion data (including the profile), a level of error (e.g., an error value) can be estimated to assign weight to the new location data and/or associated hypothesis accordingly. In some instances, if the user has not moved much (i.e., stationary) based on the motion data, but the new location data of a provider indicates that the user has moved a distance (e.g., 50 meters), then that location data/hypothesis may be discounted heavily (or assigned very low weight) due to high level of errors.

As another example, if a hypothesis has been deemed unlikely with low confidence, for example, its location estimate is not stable, and motion data also provides a conflicting result (i.e., different from the location estimate), a larger error value (or uncertainty) may be assumed or set. Hence, a low weight may be assigned to the hypothesis.

As a further illustration, suppose hypothesis A fuses location providers 1 and 2, while hypothesis B includes only location provider 3. For hypothesis A, a weighted average of location providers 1 and 2 may be used to create a location estimate for hypothesis A. If the location provider 1 aligns well with the motion data over time while location provider 2 gradually diverges or moves far away from the motion data, higher weight is assigned to location provider 1 and lower weight is assigned to location provider 2. As time goes by, the weight assigned to location provider 2 further decreases to become zero after a certain threshold of time period. The weight assigned to each location provider in hypothesis A may be proportional to how closely the location data of each location provider aligns with the motion data, and is adjusted over time. The sum of all assigned weights does not need to be 1.0.

In some embodiments, another hypothesis N may be formed for location provider 2 after its location data diverges from its prior data (e.g., the location estimate of hypothesis A). As a result, hypothesis N containing only location provider 2 may be removed eventually since its location data does not align with the motion data, which results in nearly zero weight, such that hypothesis N receives no provider fixes. Such a process can gradually remove bad location data.

Additionally, when location providers disagree with each other, different weights may be assigned by looking at contextual information. For example, in an indoor context, more weight may be assigned to location data from Wi-Fi than other providers (e.g., GPS or cellular communications) because Wi-Fi tends to be closer to the truth in an indoor context. Prior belief may also be given some weight because location changes are more likely to be a smooth change than a sudden change. Prior belief may include, but is not limited to, the prior location of the mobile device, the prior likely hypotheses that might be different from the current likely hypothesis, and the likelihoods of the prior hypotheses. This prior information may be carried forward over time and affect current and future hypotheses. In other words, the location estimates in the location controller are temporally dependent.

Sometimes, the location controller may determine that only one hypothesis is likely valid among many hypotheses and use that hypothesis to output a location estimate. In other embodiments, multiple hypotheses may be deemed likely based on the motion data, and a weighted average may be performed on these hypotheses (called joint hypothesis) to generate a final location estimate. For example, if hypothesis A's location estimate, which may be based on a single location provider or a weighted average of location providers, aligns well with motion data over a period of time than other hypotheses, hypothesis A may be determined to be the most likely hypothesis. In some embodiments, hypothesis A can become the most likely hypothesis simply because the overall weights assigned to its associated location providers are higher since its associated providers align well with the motion data.

As another example, if hypothesis A aligns well with the motion data while hypothesis B occasionally moves away from and back to the motion data, both hypotheses may be deemed likely valid. Thus, a weighted average between the two hypotheses (e.g., higher weight to hypothesis A than hypothesis B) may be used to generate the final location estimate instead of completely removing hypothesis B. In such a joint hypothesis scenario, a displayed location (e.g., a blue dot) on the mobile device based on a joint hypothesis may be a location between the two hypotheses but closer to the one with a higher weight while having a big uncertainty ring/bubble around the blue dot.

For the weighted average of the providers with filtering, the Kalman filter with Adaptive R matrix technique may be used by calculating covariances based on the behavior of the providers over time. Kalman filter may perform filtering and outlier detection on location data of location providers (e.g., Wi-Fi or cellular fixes) instead of allowing the data to pass through. Uncertainty R may be decided by comparing changes in the providers' reported locations. Each hypothesis may perform its decorrelation and data fusion functions. Different hypotheses may be treated as measurements to a Kalman filter but with different noise covariance matrices (R matrix).

Motion data may also be considered when applying the filtering technique. In some embodiments, the Chapman-Kolmogorov part of a Bayesian estimation may be used to compute the predicted probability density function of each hypothesis using applicable motion data, such as pedestrian dead reckoning (PDR).

### D. Process Flows for Location Fusion/Selection

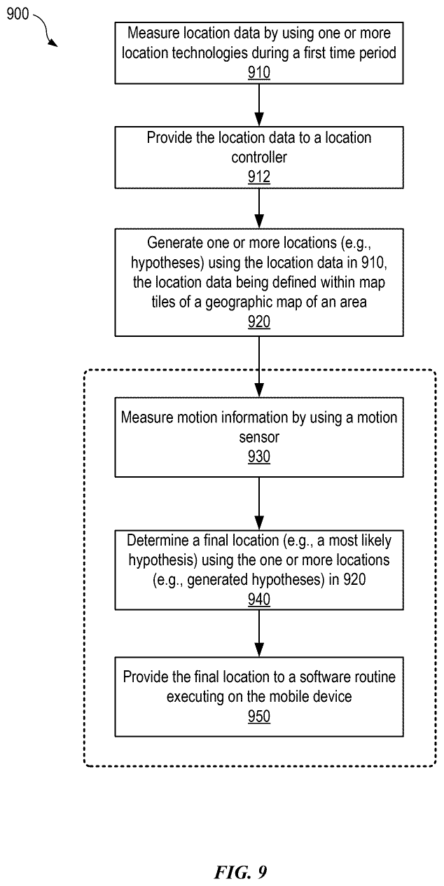

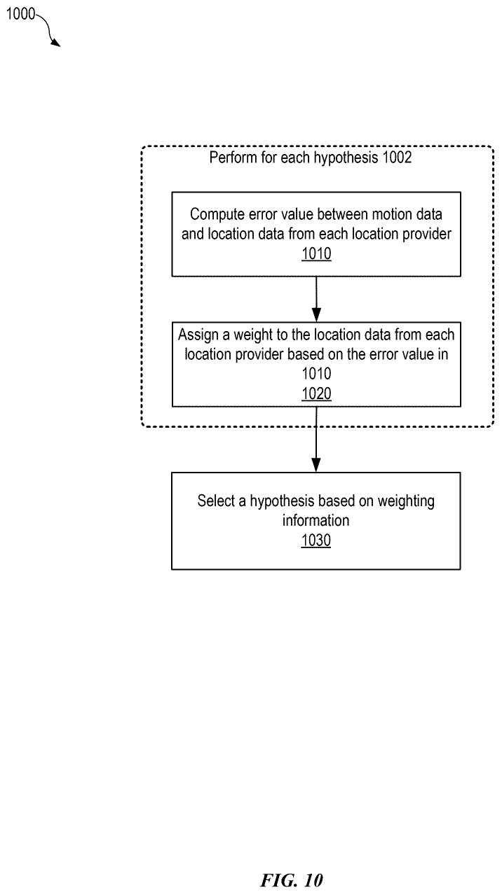

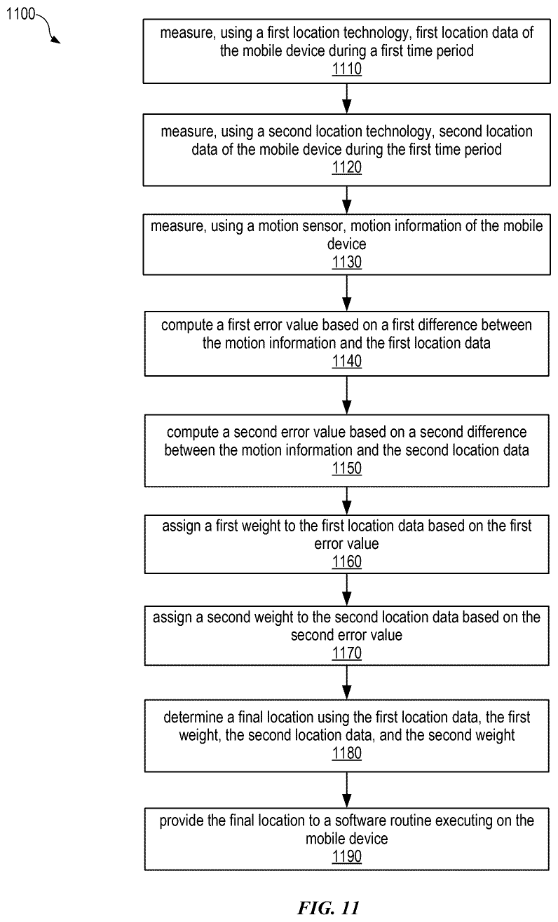

A location controller can fuse location data from multiple location providers to generate one or more hypotheses, apply weighting mechanisms to the location data based on motion data, and select a hypothesis to display a final location on a mobile device. FIG. 9 illustrates the overall process performed by the location controller. FIGS. 10 and 11 illustrate the aspect of applying a weighting mechanism by the location controller.

### 1. Performing Location Data Fusion and Hypothesis Selection

As discussed above, location data fusion and hypothesis selection may involve various processes performed by different pipeline stages, including receiving location data from one or more location providers, generating hypotheses based on the received location data, using motion information to determine a most likely hypothesis, and display a final location on a mobile device based on the selected hypothesis.

FIG. 9 is a flowchart illustrating a method 900 for performing location data fusion and hypothesis selection of a location controller, according to some embodiments. In some implementations, one or more method blocks of the method 900 may be performed by one or more processors of a mobile device. Additionally, or alternatively, one or more method blocks of the method 900 may be performed by one or more components of a mobile device, such as processor 918 of FIG. 9. The mobile device can be a phone or a wearable device (e.g., a watch).

At block 910, location data is measured by using one or more location providers/technologies during a first-time period. As discussed earlier, a location controller (e.g., 700 or 800) may receive location data from various location providers, such as GPS fixes, Wi-Fi fixes, and cellular data, etc. Additional historical data, such as buffered Wi-Fi scans and buffered GPS fixes, may be received and considered to be the same location data as their corresponding providers. For example, in FIG. 6, location data is measured by providers 1 620, provider 2 630, and provider 3 640 during a particular time period.

At block 912, the location data is provided to a location controller. For example, the location data measured by the providers is provided to a location controller of a mobile device (e.g., 210).

At block 920, one or more locations (e.g., hypotheses) are generated using the location data in 910, the location data being defined within map tiles of a geographic map of an area. As discussed earlier, one hypothesis (e.g., hypothesis B 652 of FIG. 6) may be formed or generated based on location data from a location provider. One hypothesis (e.g., hypothesis A 650) may also be formed based on location data from multiple location providers (e.g., provider 1 620 and provider 2 630) if the data from different providers are sufficiently similar. Additionally, one of the location providers in an existing hypothesis may be separated to become a new hypothesis if the location data of that location provider diverges from the existing hypothesis.

At block 930, motion data may be measured by using a motion sensor. For example, in FIG. 6, motion data about the movement of the mobile device may be measured by a motion sensor in the mobile device 610, and then provided to the location controller to use as a source for measuring the location progress over time. The motion data can help identify outlier location data and outlier hypotheses as discussed earlier in relation to FIGS. 7 and 8.

At block 940, a final location (e.g., a most likely hypothesis or a joint hypothesis) is determined by the location control using the one or more locations (e.g., generated hypotheses) in 920. As discussed earlier, one hypothesis may be determined to be the most likely hypothesis with the assistance of motion data and contextual information. The determination may be based on how close the location estimate of each hypothesis is to the motion data of the mobile device or the overall weight(s) in each hypothesis. However, in some instances, more than one hypothesis may be considered likely valid, and a joint hypothesis (as the most likely hypothesis) may be generated using a weighted average of multiple hypotheses. For example, in FIG. 6, hypothesis A 650 may be determined to be the most likely hypothesis because the location data (622 and 632) from its associated providers 1 and 2 (620 and 630) aligns well with the motion data 690.

At block 950, the final location based on the determined hypothesis in 940 is provided a software routine executing on the mobile device. As discussed above, the final location may be displayed as a dot that is the same as the location estimate (e.g., 680 of FIG. 6) of a selected hypothesis (e.g., hypothesis A 650), or somewhere between the location estimates of two or more hypotheses, as in a joint hypothesis scenario. The output rate of that final location may depend on how the most likely hypothesis is selected/determined.

### 2. Applying Weighting Mechanisms

As discussed above in relation to FIGS. 7 (e.g., 740) and 8 (e.g., 848), weighting mechanisms may be used to increase or reduce the importance of location data from location providers in hypotheses after detecting outlier providers by utilizing motion data, and also used to select a most likely hypothesis or a joint hypothesis.

FIGS. 10 and 11 are flowcharts illustrating a method for applying a weighting mechanism when performing location data fusion and hypothesis selection of a location controller, according to some embodiments. FIG. 10 describes the general process of applying a weighting mechanism involving in blocks 930, 940, 950 of FIG. 9. FIG. 11 provides further sub-steps for one or more steps in FIG. 10.

In FIG. 10, at block 1002, which includes block 1010 and block 1020, for each hypothesis, a weight is determined and assigned to each location provider in that hypothesis.

At block 1010, an error value (or IO displacement) between the motion data (involving block 930 of FIG. 9) and location data from each location provider is computed (or calculated). Since the motion data is the primary source of determining how the location progresses for the mobile device, the location data of a provider that aligns with the motion data should be favored. An error value can be used to quantify how closely the location data of a provider aligns with the motion data. For example, in FIG. 6A, an error value may be calculated for each provider of providers 1, 2, and 3 (620, 630 and 640). The error value for provider 620 may be the smallest because its location data 622 aligns well with the motion data since both are moving south. The error value for provider 3 640 may be the largest because its location data 642 is moving in a very different direction (northwest) from the motion data (south). The error value for provider 2 630 may be relatively small because its location data 632 is moving in a direction that has only a 25-degree difference from the motion data.

At block 1020, a weight is assigned to the location data of each location provider based on the error value calculated in 1010. As discussed above, a weight may be determined based on many factors, such as motion data, contextual information, prior belief, etc. For motion data, the weight may be inversely proportional to the calculated error value. In other words, the smaller the error value (i.e., location data closely aligns with motion data), the higher the weight is assigned (i.e., the more the data is favored). Vice versa for a larger error value. For example, in FIG. 6A, the location data 622 of provider 1 620 may be assigned a higher weight than the weight assigned to the location data 632 of provider 630. As a result, the location estimate 680 of hypothesis A 650 is closer to provider 1's location 622.

Additionally, different contexts may also affect the weight assignments to location data of different providers. In some embodiments, the Kalman filter with the Adaptive R matrix technique can be applied when performing a weighted average of the location providers.

At block 1030, a hypothesis is selected based on weight information. As discussed above, weights may be applied at the location provider level (i.e., within a hypothesis) and/or at the hypothesis level. When weights are applied at the provider level, a hypothesis can be selected as the most likely hypothesis because the overall weights assigned to its associated location providers are higher since its associated providers align well with the motion data. For example, in FIG. 6A, hypothesis A 650 may be selected as the most likely hypothesis because its associated providers 1 and 2 (620 and 630) are assigned higher weights than provider 3 640 in hypothesis B 652.

For weights applied at the hypothesis level, such as the joint hypothesis scenario as shown in FIG. 6B, weights are assigned based on the IO displacement between the location estimate of each hypothesis and the motion data. For example, in FIG. 6B, hypothesis A 650 and hypothesis C 654 are two likely hypotheses, hypothesis A 650 may be assigned a higher weight because the IO displacement for its location estimate 680 is smaller (i.e., aligns well with the motion data 690) than the IO displacement for location estimate 684 of hypothesis C 654.

As discussed above, weights assigned to the location data of different providers depend on their respective IO displacements. FIG. 11 is similar to FIG. 10, but provides more details about the weight determination in block 1010 and assignment in block 1020.

Referring to FIG. 11, at block 1110, first location data is measured using a first location technology (or provider) of the mobile device during a first time period. For example, in FIG. 6, location data 622 is measured by providers 1 620 during a particular time period.

At block 1120, second location data is measured using a second location technology (or provider) of the mobile device during the first time period. For example, in FIG. 6, location data 632 is measured by providers 2 630 during a particular time period.

At block 1130, motion information of the mobile device is measured using a motion sensor. For example, in FIG. 6, motion data 690 may be measured by a motion sensor in the mobile device 610. The motion data may be movement (e.g., change in position over time, including orientation/direction, speed, etc.) of the mobile device.

At block 1140, a first error value is computed based on a first difference between the motion information and the first location data. For example, in FIG. 6, the difference in movement between the motion data 690 and the location data 622 may be used to compute an error value, which for example, may be the degree of difference in the moving direction. In this case, both location data 622 and the motion data 690 are moving south with similar distance. Thus, the error value may be close to 0.

At block 1150, a second error value is computed based on a second difference between the motion information and the second location data. For example, in FIG. 6, the difference in movement between the motion data 690 and the location data 632 may be used to compute an error value, which may be the degree of difference in the moving direction. In this case, the location data 622 and the motion data 690 have a 25-degree difference in their moving directions.

At block 1160, a first weight is assigned to the first location data based on the first error value. As discussed above, the weight assigned may be inversely proportional to the calculated error value. For example, in FIG. 6, a high weight (e.g., 0.95 out of 1 or other types of indicators to show importance) may be assigned to the location data 622 because it closely aligns with the motion data 690 (i.e., an error value close to 0).

At block 1170, a second weight is assigned to the second location data based on the second error value. For example, in FIG. 6, an above-medium weight (e.g., 0.8 out of 1 or 25-degree/180-degree) may be assigned to the location data 622 because it has a 25-degree difference from the motion data 690.

At block 1180, a final location is determined using the first location data, the first weight, the second location data, and the second weight. For example, in FIG. 6, the location estimate 680 of hypothesis A 650 may be determined based on the location data 622, the first weight 0.95, the location data 632, and the second weight 0.8. The location estimate 680 is closer to the location data 622 because of its higher weight (0.95).

At block 1190, the final location may be provided to a software routine executing on the mobile. In some embodiments, the software routine executing on the mobile device may be a user interface configured to display the final location 680, as shown in FIG. 6.

### E. GNSS Architecture

The mobile device may place the application processor in a low power state to conserve the device's battery. The mobile device may place the application processor in a low power state when the device is at a dwell point, and the mobile device may not be able to perform GNSS tracking in this low power state. However, a dwell point can be a location where the mobile device is likely to remain for above a threshold amount of time. Accordingly, the mobile device may not move significantly at a dwell point and GNSS tracking may not be necessary. The mobile device's auxiliary processor can record inertial measurements during the low power state and, when the application processor wakes, the inertial measurements can be evaluated to determine if the device has left a dwell point. In response to leaving a dwell point, the mobile device may periodically perform GNSS tracking to record the device's location.

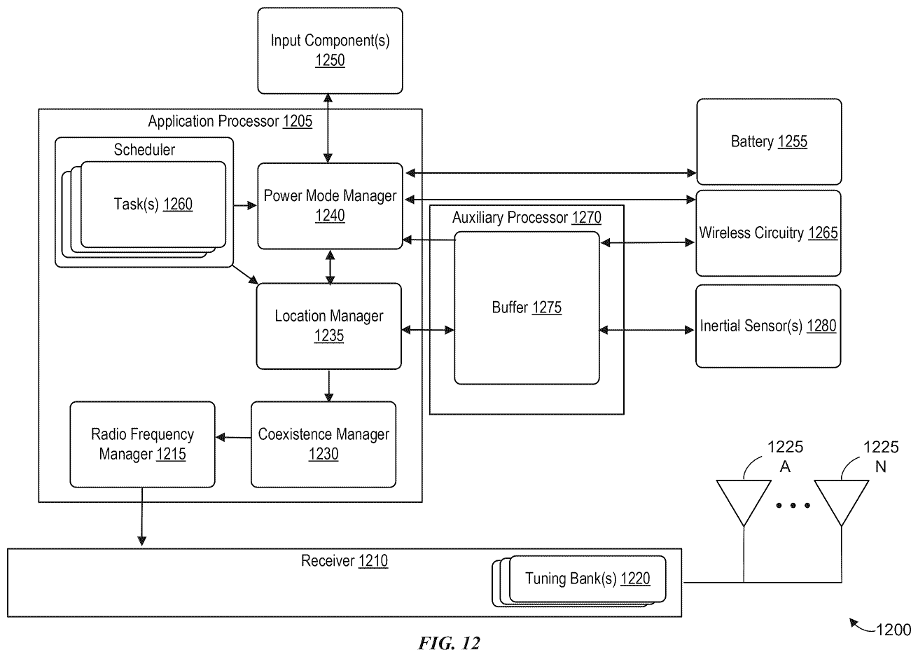

FIG. 12 is a simplified diagram 1200 of an architecture for GNSS navigation according to various embodiments. Processes executing on application processor 1205 can implement tuning logic and instruct receiver 1210 to perform GNSS measurements using the GNSS circuitry or change the tuning state for one or more antennas. Application processor 1205 can be part of a mobile device such as user equipment 12. In addition, receiver 1210 can be similar to receiver 128 and application processor 1205 and auxiliary processor 1270 can be similar to processor 22 described above. Instructions to the receiver 1210 can be sent by a radio frequency manager 1215 and the receiver can perform GNSS measurements or connect or disconnect one or more of the tuning bank(s) 1220 to the antennas 1225a-425n in response to the instructions. Changing the tuning bank(s) 1220 can change the tuning state for the antennas 1225a-425n and the performing GNSS measurements may involve changing the tuning state for these antennas.

The tuning logic can be implemented by the coexistence manager 1230 which can integrate information from the other processes executing on processor 1205 to make decisions about changing the tuning state. Upon determining that the tuning state should change, the coexistence manager 1230 can instruct the radio frequency manger to change the tuning state for antennas 1225a-425n. The tuning logic can include changing the tuning state based on the GNSS mode (e.g., acquisition, or tracking), the thermal state (e.g., thermal event; whether temperature is stable or fluctuating), or the power state of the mobile device (e.g. the charge in the device's battery; whether the device is charging).

Location manager 1235 can process signals received at the antennas and provide information about the current GNSS mode to the coexistence manager 1230. Signals received at the antennas 1225a-425n can be forwarded to the location manager 1235 via receiver 1210, radio frequency manager 1215, and coexistence manager 1230. The location manager 1235, the antennas 1225a-425n, receiver 1210, radio frequency manager 1215, and coexistence manager 1230 can be collectively referred to as the GNSS circuitry. The location manager can interpret the signals and determine a location for the mobile device.

The location manager 1235 can request location functionality from the coexistence manager 1230. For instance, the location manager 1235 can receive a request for location functionality from one or more scheduled task(s) 1260. In response to the request, the location manager can request information about signals received at the antennas 1225a-425n from the location manager 1235. In response, the coexistence manager 1230 can request that the radio frequency manager 1215 acquire a connection with a satellite and perform tracking. The request from the coexistence manager 1230 can include an instruction to change the tuning state or tracking mode depending on the current tracking mode.

Power mode manager 1240 can cause the application processor to enter or exit a low power state to conserve power. In a low power state, the power mode manager 1240 may limit the frequency (e.g., clock speed) of one or more of the processing units (e.g., cores) in the application processor 1205. When the application processor 1205 is in a low power state, tasks intended for the application processor 1205 can be stored in a buffer 1245 by the auxiliary processor 1270. When the application processor 1205 leaves the low-power mode, the application processor 1205 can process the queued tasks. The tasks can be queued by the auxiliary processor 1270 which can be a processor that is powered on more frequently than the application processor 1205 (e.g., the application processor 1205 is powered on less frequently than the auxiliary processor).

The power mode manager 1240 can use one or more rules to cause the application processor 1205 to enter or exit the low power state. For example, the power mode manager 1240 can cause the application processor 1205 to enter the low power state based on information received from input component(s) 1250. For example, the input component(s) 1250 can include one or more touchscreens, touchpads, or buttons and the power mode manager 1240 may cause the application processor 1205 to enter a low power state if the input to these devices is below an input threshold. The power mode manager 1240 may monitor the state of battery 1255 and the input threshold may change depending on the current capacity of battery 1255. For example, the input threshold may be higher when the capacity of battery 1255 is below a battery threshold.

In addition, the power mode manager 1240 can monitor scheduled task(s) 1260 from one or more application(s) to determine whether to cause the application processor 1205 to enter the low power state. For example, the power mode manager 1240 may not enter the low power state if a threshold number of tasks(s) 1260 for the application(s) are scheduled for execution on the application processor. The priority of the application(s), or the priority of the scheduled task(s) 1260, may determine whether the power mode manager 1240 causes the application processor 1205 to enter the low power state. In addition, the threshold number of scheduled task(s) 1260 may vary based on the capacity of battery 1255 (e.g., whether the capacity is above or below one or more thresholds). Any combination of the techniques described with reference to the power mode manager 1240 may be used to determine whether to cause the power mode manager 1240 to instruct the application processor 1205 to enter the low power state.

The power mode manager 1240 can cause the application processor 1205 to exit the low power state based on information received from input component(s) 1250. For example, the power mode manager 1240 may cause the application processor 1205 to exit a low power state if the input to these devices is above an input threshold. The power mode manager 1240 may monitor the state of battery 1255 and the input threshold may change depending on the current capacity of battery 1255. For example, the input threshold may be higher when the capacity of battery 1255 is below a battery threshold. The battery threshold for entering the low power state may be higher or lower than the input threshold for leaving the low power state. In addition, the power mode manager 1240 can monitor scheduled task(s) 1260 from one or more application(s) to determine whether to cause the application processor 1205 to exit the low power state. For example, the power mode manager 1240 may exit the low power state if a threshold number of tasks(s) 1260 for the application(s) are scheduled for execution on the application processor. The priority of the application(s), or the priority of the scheduled task(s) 1260, may determine whether the power mode manager 1240 causes the application processor 1205 to exit the low power state. In addition, the threshold number of scheduled task(s) 1260 may vary based on the capacity of battery 1255 (e.g., whether the capacity is above or below one or more thresholds).

The power mode manager 1240 may exit the low power state in response to input from the wireless circuitry 1265. For example, the power mode manager 1240 may cause the application processor 1205 to leave the low power state if information from the wireless circuitry 1265 indicates that the device has connected or disconnected from a wireless access point. In addition, the auxiliary processor 1270 may instruct the power mode manager 1240 to wake the application processor 1205. For example, the auxiliary processor 1270 may provide information about the capacity of buffer 1275 to the power mode manager 1240, and the power mode manager 1240 may wake the application processor 1205 if the capacity of buffer 1275 is above a threshold. In some embodiments, the power mode manager 1240 may wake (e.g., cause the application processor to exit the low power state) at regular intervals. Any combination of the techniques described with reference to the power mode manager 1240 may be used to determine whether to cause the power mode manager 1240 to instruct the application processor 1205 to exit the low power state.

The wireless circuitry 1265 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 1265 can use various protocols, e.g., as described herein. In various embodiments, wireless circuitry 1265 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 902.11a, IEEE 902.11b, IEEE 902.11g and/or IEEE 902.11n), Bluetooth, Wi-MAX, Voice Over Internet Protocol (VoIP), near field communication protocol (NFC), a protocol for email, instant messaging, and/or a short message service (SMS), or any other suitable communication protocol, including communication protocols not yet developed as of the filing date of this document.

The location manager 1235 may use one or more rules to detect whether a device with architecture 1200 has left a dwell point. A dwell point can be a location where the device has persisted for a threshold amount of time, or a location where information indicates that the device is likely to persist for a threshold amount of time. For example, wireless circuitry 1265 may provide the location manager 1235 with information indicating the wireless access points that are in range of the device (e.g., access points for which signals have been received within a threshold amount of time). Wireless access points may need to be within a threshold distance of the wireless circuitry for the access points to be in range, and changes to the access points that are in range, or changes to their signal strength, may indicate that the device is moving (e.g., not dwelling).

In addition or alternatively, the wireless circuitry 1265 may indicate one or more wireless access points that are connected to the device, and changes to the connected access points may indicate that the device has left a dwell point. Any combination of information identifying a particular configuration of in range access points, the current signal strength of some or all of those access points, or any connected access points can be referred to as a wireless fingerprint. In some embodiments, the wireless fingerprint may include information identifying any paired periphery devices (e.g., a Bluetooth mouse) that are connected to the device with architecture 1200. Changes to the wireless fingerprint may be used by the location manager 1235 to determine if the device with architecture 1200 has entered or exited a dell point.

The location manager may use information from inertial sensor(s) 1280 to determine that the device with architecture 1200 has entered or exited a dwell point. The information from inertial sensor(s) 1280 (e.g., inertial information) can be provided to location manager 1235 in a raw form, or the auxiliary processor 1270 may process the measurements before providing the inertial information to the location manager. For example, the measurements may include linear and angular acceleration measurements in multiple axes and processing may include calculating higher order derivatives from these measurements. The inertial sensor(s) can include one or more accelerometers, one or more magnetometers, one or more gyroscopes, or any other sensor for measuring changes to the position and orientation of the device.

The auxiliary processor 1270 may store wireless fingerprint(s) and the inertial information in a buffer 1275. For example, the location manager 1235 may not be active when the application processor 1205 is in a low power state. Between wake events, the auxiliary processor 1270 may measure and record the outputs of any combination of wireless circuitry 1265 and inertial sensor(s) 1280 in the buffer 1275. At each wake event, the location manager 1235 may access any combination of the stored wireless fingerprint(s) and inertial information from buffer 1275. In some embodiments, the auxiliary processor 1270 may instruct the power mode manager 1240 to wake the application processor 1205 in response to the memory utilization of the buffer 1275 exceeding a threshold (e.g., the buffer is full). The location manager 1235 may perform operations with this accessed information to determine whether the device with architecture 1200 has entered or exited a dwell point. The operations may include any combination of comparing the accessed information to one or more rules and providing the accessed information as input to one or more machine learning models.

The location manager 1235 may process the accessed information before performing the operations. For example, the location manager 1235 may generate features vectors representing the inertial information (e.g., inertial feature vectors) and provide those feature vectors to one or more machine learning model that are trained to classify the movement of the device with architecture 1200. These machine learning models can output any combination of a total displacement of the device (e.g., distance and direction), a total change in orientation, a net displacement, and a net change in direction for a given feature vector. This output can be referred to as an inertial classification. An inertial feature vector may represent the output of the inertial sensor(s) 1280 over a fixed interval (e.g., 20 seconds) or between events (e.g., between a sleep event and the proximate wake event). This feature vector can be an ordered list of numeric properties corresponding to the output of the inertial sensors over a given time period. In some embodiments, the machine learning models may be able to classify a movement type for a given inertial feature vector. For example, the movement type (e.g., the movement classification) may be in a vehicle, walking, running, sitting, standing, riding a bicycle, riding a skateboard, riding a scooter, etc. An inertial classification can include one or more movement classifications.

The location manager 1235 may use any combination of the wireless fingerprint(s), the inertial information, the inertial classification(s), and the movement classification(s) to perform operations to determine whether the device with architecture 1200 has entered or exited a dwell point. Each determination by the location manager 1235 that the device has left a dwell point can be referred to as an exit trigger. Each determination by the location manager 1235 that the device has entered a dwell point can be referred to as an entrance trigger. In some embodiments, the operations may include providing input to one or more machine learning models as described above. The output of the one or more machine learning models may be a confidence score (e.g., a probability that an exit event has occurred). The location manager 1235 may provide input to the one or more machine learning models over a period of time (e.g., over sequential wake events). If the confidence score exceeds a first threshold, the location manager 1235 may classify the output as a preliminary exit event. If a subsequent confidence score exceeds a second threshold, or if the first threshold is exceeded for a threshold number of sequential confidence scores, the preliminary exit event may be classified as a confirmed exit event.

The location manager 1235 may instruct the GNSS circuitry to perform GNSS measurements at each wake event that occurs after an exit event and before an entrance event (e.g., until the next dwell point is reached). The location manager 1235 may use the GNSS measurements to determine a GNSS location, and the GNSS location, and a corresponding time, may be logged for each set of measurements. The time can be a time of the wake event or a time that the GNSS measurements were performed.

The location manager 1235 may report exit events to the power mode manager 1240. The power mode manager 1240 may periodically wake the application processor 1205 to perform GNSS measurements in response to a wake event (e.g., every 30 seconds). In some embodiments, the rate at which the location manager 1235 wakes the application processor 1205 may depend on whether the exit event is a preliminary or confirmed exit event. For example, the location manager 1235 may perform GNSS measurements at opportunistic wake events after a preliminary exit event, but the power mode manager 1240 may only periodically wake the application processor 1205 after a confirmed exit event. In another example, the power mode manager 1240 may wake the application processor at a first rate (e.g., every 30 seconds) in response to a preliminary exit event and a second rate (e.g., every 13 seconds) after a confirmed exit event.

### F. Displacement Model

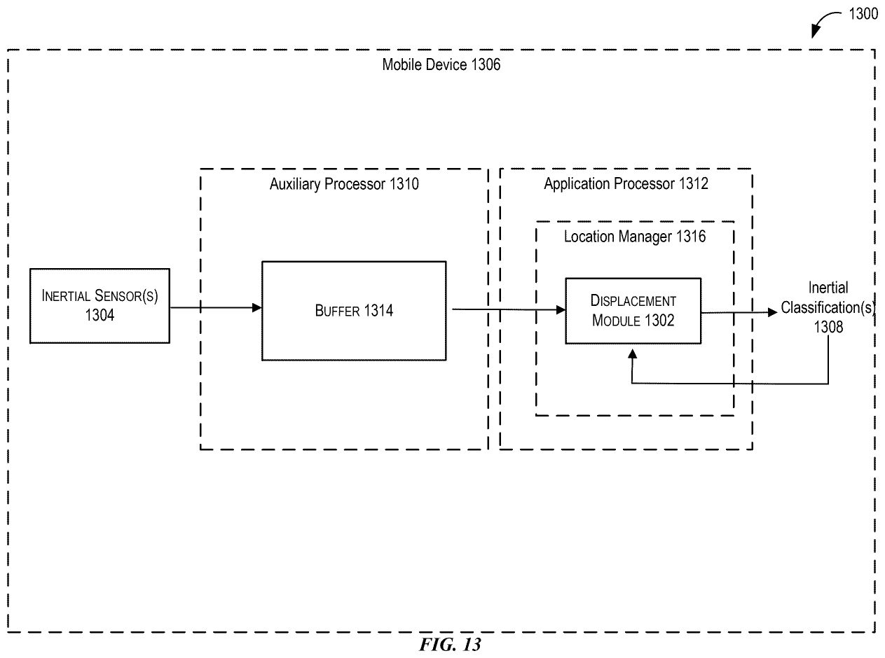

FIG. 13 shows a simplified diagram 1300 of an architecture for predicting the displacement of a mobile device according to embodiments of the present disclosure. The architecture can include models that use output from various motion sensors, and magnetometer readings, to estimate the displacement of a mobile device. The architecture can include one or more machine learning models that use motion sensor and magnetometer outputs to classify a motion type for the mobile device. This estimated displacement and motion type can be used to classify inertial measurements to obtain inertial classifications (e.g., by comparing any combination of the displacement and motion type to one or more rules). These machine learning models can be part of a displacement module that can execute on the application processor or auxiliary processor of the mobile device. In some embodiments, the displacement module can be one or more machine learning models that form part of the location manager (e.g., location manager 1235).

The architecture can include a displacement module 1302 that can use sensor values from inertial measurement unit (IMU) sensor(s) 1304 to determine the displacement of a mobile device 1306 as the device moves within a physical environment. In some embodiments, the displacement can be the change in position of the body of a user of the mobile device. As examples, the sensor values output by the inertial sensor(s) 1304 can be a direction of gravity relative to the tracking mobile device 1306, an acceleration in a vertical plane parallel to gravity, acceleration in a horizontal plane perpendicular to gravity, a rotation (e.g., yaw) of the tracking mobile device, a pitch of the tracking mobile device relative to gravity, a roll of the tracking mobile device relative to gravity, gyroscope readings (e.g., rotational acceleration readings), and a compass (e.g., magnetometer) reading.

The sensor values output from the inertial sensor(s) 1304 that are input to the displacement module 1302 can be linear acceleration (e.g., one or more of the horizontal and vertical acceleration), rotational acceleration (e.g., acceleration around one or more axes), and magnetometer readings (e.g., magnetic field measurements along one or more axes). The displacement module 1302 can use this input to calculate a displacement (e.g., a net change in position over a time period) of the tracking mobile device 1306. For example, the displacement module 1302 may take the second integration of an acceleration measured by the inertial sensor(s) 1304 to determine the displaced distance, and the rotational acceleration and magnetometer readings can be used to determine the displacement's change in orientation. The first integration of the acceleration can produce velocity and the second integration of the acceleration can produce the distance. The displacement module 1302 can use a magnetometer reading to determine the orientation of the mobile device 1306 at each calculated position. The model may separately determine location and orientation, and, in some embodiments, the displacement module 1302 may include a model for determining location and a model for determining orientation. The displacement can be a net change of two-dimensional or three-dimensional coordinates in any coordinate system (e.g., cartesian coordinates). In some embodiments, the displacement can include coordinates and an orientation relative to a reference direction (e.g., relative to magnetic north).

The input to the displacement module 1302 can be an ordered list of numeric properties corresponding to the current displacement of mobile device 1306 (e.g., inertial classification(s) 1308). For example, the displacement module may output inertial classification(s) 1308 that include a current displacement for the mobile device 1306. The displacement may use numeric properties of these inertial classification(s) 1308, and numeric properties of the inertial sensor(s) 1304, as input to determine additional inertial classification(s) 1308. For example, a displacement may be used as input to the displacement module so that the module can determine a motion classification (e.g., walking, running, sitting, etc.).

This ordered list can be a feature vector, and the feature vector can include the output of inertial sensor(s) 1304. For example, the feature vector can include linear acceleration along three perpendicular axes, an angular acceleration around the three axes, and a magnetic field in the three axes. The linear accelerations can be output by one or more accelerometer(s) of the inertial sensor(s) 1304, the angular acceleration can be output by one or more gyroscope(s) of the inertial sensor(s) 1304, and the magnetic fields can be output by one or more magnetometer(s) of the inertial sensor(s) 1304.

In some implementations, the feature vector can include transformations of the output of the inertial sensor(s) 1304. For example, the feature vector can include higher order derivatives calculated from the output of the inertial sensor(s) 1304 (e.g., position calculated from acceleration). The transformations can include statistical operations such as excluding outlier measurements or calculating aggregated statistics for the output of the inertial sensor(s) 1304 (e.g., mean, median, mode, standard deviation, etc.). The output of the inertial sensor(s) 1304 may be the output of the inertial sensor(s) over a period of time and a feature vector may be generated for each period of time (e.g., the time period between sequential wake events). The feature vector for a current time period may include information for one or more preceding time periods. For example, the feature vector may include inertial classification(s) 1308 for one or more preceding time periods or the output of inertial sensor(s) 1304 over different time periods. The output of the inertial sensor(s) may be processed before the output is included in a feature vector. For example, the output of the inertial sensor(s) 1304 may be rotated from a first frame of reference to a second frame of reference (e.g., so that the data represented in the feature vector is in a single reference frame). The transformations or processing may be performed by any combination of the auxiliary processor 1310 and application processor 1312.

In some embodiments, the auxiliary processor may store the output of the inertial sensor(s) 1304 to a buffer 1314. The output can be stored in the buffer 1314 at times when the application processor 1312 is in a low power state, and, in response to the application processor 1312 leaving the low power state, the buffered output of the inertial sensor(s) 1304 can be provided to the displacement module 1302 in application processor 1312. The auxiliary processor 1310 can perform one or more transformations or processing of the output before the output of the inertial sensor(s) 1304 is saved to the buffer 1314. In some embodiments, the raw output of the inertial sensors can be saved to the buffer 1314 and any transformations or processing can be performed by the application processor 1312. In some embodiments, displacement module can be part of a location manager 1316 that executes on the application processor 1312.

### V. Logging Locations Between Dwell Points

Recording a log of a mobile device's location over time may be desirable. For example, the log may memorialize a vacation or be used as a prompt for a journaling application. In addition, the log may allow a device's user to trace their previous location to locate sunglasses that were dropped on their journey. Such a log may be recorded through periodic GNSS measurements that can be used to determine the mobile device's location.

However, performing GNSS measurements can be energy intensive and recording a log of GNSS locations can drain the mobile device's battery capacity. GNSS measurements can energy intensive because the measurements may be performed and processed by the mobile device's application processor. The mobile device's application processor may be in a low power state to conserve power when it is not in use. Each GNSS measurement may require the application processor to wake (e.g., leave the low power state) and these wake events can increase the mobile device's power consumption.

In addition, there also may be circumstances where performing GNSS measurements is not necessary for an accurate log. For example, a user who is spending the afternoon working from a coffee shop may not change locations for hours. In such circumstances, a first GNSS location determination provides sufficient information for the log and any subsequent location determinations consume power without providing relevant information. Accordingly, the mobile device can save its battery capacity by reducing the frequency of GNSS measurements, and wake events, when the user is staying at a particular location (e.g., at a dwell point).

### A. Moving Between Dwell Points

The mobile device can save power by distinguishing between positions where the mobile device is likely to persist for a threshold amount of time (e.g., dwell points), and circumstances where the mobile device is moving between these points. Periodic GNSS measurements could be used to determine if a user has left a dwell point. However, if the rate at which GNSS measurements are performed is too high, the power savings may be limited because each measurement may require waking the auxiliary processor from the low power state and performing energy intensive measurements. But if the rate is too low, the log may not accurately record the mobile device's location because of a delay between leaving a location and initiating the log.

The energy savings, and accuracy, can be improved by using an auxiliary processor to measure information about the mobile device between wake events. This information can be stored in a buffer by the auxiliary processor and the mobile device's application processor can use the stored information to detect exit events at wake events. The measured information can include inertial information from the mobile device's inertial sensors and wireless fingerprints measured by the device's wireless circuitry. Both storing this information, and using the information to identify exit events, can be less power intensive than GNSS measurements. In addition, the measured information may be processed opportunistically (e.g., when the application processor wakes because of user input) and predicting exit events may not cause an appreciable increase in power consumption because the processing occurs when the application processor is already active.

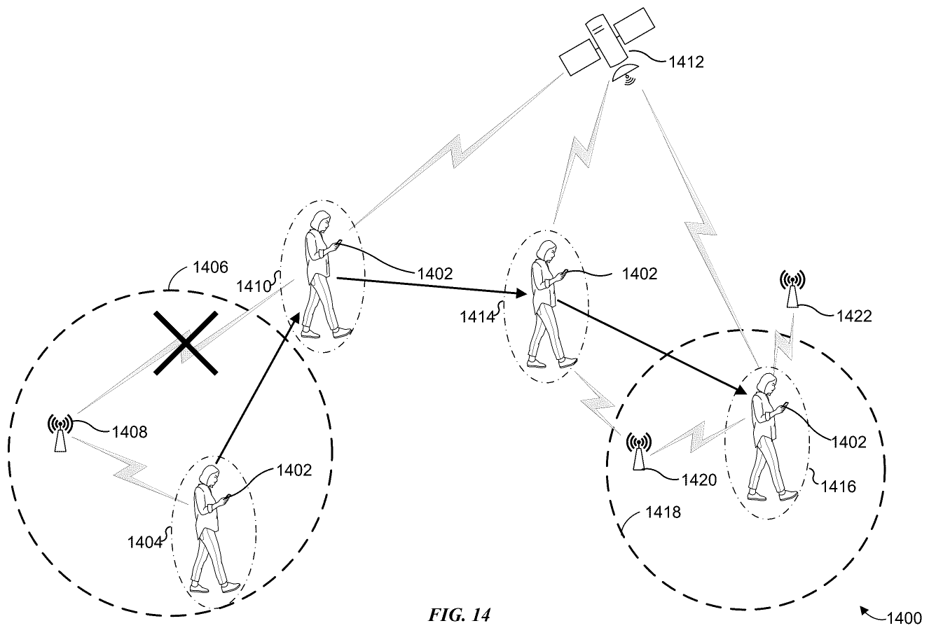

FIG. 14 is a simplified diagram showing a mobile device traveling between dwell points according to various embodiments. Mobile device 1402 is with the device's user at a first location 1404. The first location 1404 is within a first dwell point 1406, and this first dwell point can be a known dwell point where mobile device 1402 has previously spent time. For example, the first dwell point 1406 can be the user's home, the user's workplace, the user's school, the user's local coffee shop, or any other location where the user would spend a threshold amount of time. Mobile device may identify the first dwell point as a known location because the mobile device 1402 has received a signal from, or connected to, wireless access point 1408 and the mobile device 1402 recognizes this wireless fingerprint as corresponding to a known location (e.g., the fingerprint has been recognized a threshold number of times).

The mobile device 1402 may treat the first dwell point 1406 as a known dwell point even though the mobile device has not previously visited the first dwell point. For example, the mobile device may compare a GNSS location for or a wireless fingerprint corresponding to the first dwell point 1406 against a database of dwell points. The dwell points in the database can be categorized as known dwell points, where GNSS measurements may not need to be performed and logged, and unknown dwell points where GNSS measurements may need to be performed and logged.

The mobile device can compare the location and fingerprint information against the database to determine whether GNSS measurements should be performed prior to the next exit event. For example, the first dwell point 1406 may be a chain coffee shop, and, even though the mobile device 1402 has never been to the location, the database may categorize the location as a known dwell point because the location is small and there is little variance between GNSS location determinations or displacements at the coffee shop. However, a theme park that the user regularly visits may be categorized as an unknown dwell point because there is significant variance between GNSS location determinations or displacements. In addition, GNSS measurements may be paused, even if the mobile device 1402 is not located at a dwell point, if the variance between GNSS location determinations, or the magnitude of predicted displacements, is below a threshold. Pausing the GNSS measurements may include reducing the rate at which GNSS measurements are performed.

Other information may be used to differentiate between known and unknown dwell points (e.g., whether users take photographs at the location or look at the log locations corresponding to the location). The inertial information can be used to determine whether to perform GNSS location logging and, for example, the locations may be logged at a dwell point if the user is determined to be running. However, the locations may not be logged if the user is determined to be sitting.

In some embodiments, mobile device 1402 may categorize the first dwell point 1406 as a known location because of a GNSS measurement and location determination during the mobile device's current visit to first dwell point 1406. However, after recognizing that the device is at the first dwell point 1406, the mobile device 1402 may pause GNSS signal measurements, or reduce the measurement rate, until an exit event is detected. The mobile device 1402 may place the device's application processor into a low power state in response to detecting that the device is at a known location. During this low power state, the auxiliary processor of mobile device 1402 can record and store inertial information from the mobile device's inertial sensors in a buffer. In addition, or alternatively, the auxiliary processor can measure and store measurements from the wireless circuitry of mobile device 1402 in the device's buffer.

The application processor of mobile device 1402 may periodically wake from the low power state. For example, mobile device 1402 may wake because the user may interact with the mobile device 1402 (e.g., unlock the screen), the buffer may reach capacity (e.g., memory utilization exceeds a threshold), the application processor may wake at regular intervals (e.g., once a minute), the mobile device may begin charging, the mobile device may connect or disconnect from a wireless access point, etc. At each wake event, the mobile device 1402 may process the stored information to determine whether an exit event has occurred.

In addition, the mobile device 1402 may process the stored information predict whether an exit event is likely. For example, the processed information at a wake event may indicate that an exit event is likely to occur. In response, the mobile device 1402 can begin to perform GNSS measurements and location determinations. The periodic location determinations may stop after a threshold amount of time if the determined locations do not indicate that the mobile device 1402 has exited a dwell point.

As shown in diagram 1400, mobile device 1402 moved from first location 1404 to second location 1410 that is outside of the first dwell point 1406. During the movement between these two locations, the mobile device 1402 disconnected from wireless access point 1408. This disconnection event caused the application processor of mobile device 1402 to wake from the low power state and to process the stored inertial information and wireless fingerprint. This stored information is provided as input to a machine learning model, or compared to rules, and the mobile device determines that an exit event is likely based on the model's output (e.g., the probability of an exit event exceeded a threshold) or the rules. The exit event can be identified before mobile device 1402 leaves the first dwell point 1406. In response to detecting an exit event, the mobile device 1402 can begin to perform GNSS measurements with GNSS satellite 1412. While one GNSS satellite is shown in diagram 1400, GNSS measurements may be performed with any number of GNSS satellites.

Until the mobile device 1402 reaches a dwell point, the mobile device's application processor may periodically wake and perform GNSS measurements with the GNSS satellite 1412. The mobile device 1402 can use these measurements to determine the device's location, and the mobile device can store these locations, and a corresponding time for the measurements, in a log.

The application processor may be woken, and the mobile device 1402 may perform GNSS measurements, at regular intervals. For example, the mobile device 1402 may perform measurements at location 1410 and location 1414 because the application processor is woken every minute, and it took the device's user a minute to walk between these locations. In addition, or alternatively, the application processor may be woken in response to events and the mobile device may perform GNSS measurements at these wake events. For example, the user may have texted a friend at location 1410 and taken a photo at location 1414. These events may have triggered the application processor to wake and perform GNSS measurements. In some embodiments a combination of these techniques may be performed. For example, the mobile device 1402 may perform GNSS measurements at events only if the time since the last measurement exceeds a threshold (e.g., so that multiple measurements are not performed back-to-back).

The mobile device 1402 may reach a location 1416 that is within a second dwell point 1418. The second dwell point 1418 may be identified because the mobile device detects a wireless fingerprint that corresponds to the second dwell point 1418. The wireless fingerprint can be measurements of the signals received from wireless access point 1420 and wireless access point 1422. A wireless fingerprint can be a particular configuration of signals from access points. For example, mobile device 1402 may receive signals from wireless access point 1420 at location 1414 and location 1416. However, the wireless fingerprint corresponding to second dwell point 1418 may require that the signal from wireless access point 1420 have a particular signal strength before the mobile device determines that the device has reached the second dwell point 1418. In addition, or alternatively, the mobile device may need to receive a signal from both wireless access point 1420 and wireless access point 1422 before determining that the device has reached the second dwell point 1418.

In addition or alternatively, mobile device 1402 may determine that it has reached the second dwell point based on a GNSS location determined by measuring signals from GNSS satellite 1412. As discussed above, GNSS satellite 1412 may represent multiple satellites and signals from multiple satellites may be required for mobile device 1402 to reach a location determination. Upon reaching the second dwell point 1418, the mobile device may pause GNSS measurements or reduce the rate of GNSS measurements. The rate of GNSS measurements can depend on whether the second dwell point 1418 is a known dwell point or an unknown dwell point. In addition, or alternatively, the rate of GNSS measurements may depend on how long the mobile device 1402 has remained at the second dwell point (e.g., the rate decreasing as the length of time at the dwell point increases).

### B. Determining Exit Events

An exit event can be identified by comparing any combination of inertial classifications and wireless fingerprints against rules. In addition, or alternatively, the inertial classifications and wireless fingerprints can be provided as input to machine learning models that are trained to predict a probability of an exit event.

The inertial classifications can be compared against rules to identify exit events. For example, an exit may be detected if the inertial classifications indicate that the net displacement of the mobile device is above a threshold. The threshold for the net displacement (e.g., distance) can vary based on the dwell point. For instance, a dwell point corresponding to a library may be larger than a dwell point for a sandwich shop. Accordingly, the net displacement threshold for the library dwell point may be larger than the net displacement threshold for the sandwich shop. A motion classification can be used to detect an exit from a dwell point. For instance, if the inertial classifications indicate that the motion classification is “driving,” the mobile device may detect an exit because traveling in a car may be inconsistent with remaining at a dwell point. However, whether a motion classification is indicative of an exit can depend on the type of motion. For example, a motion classification of “swimming” is unlikely to correspond to an exit event, but walking may indicate an exit event. In addition, an exit event may detected if a particular order of motion classifications is observed. For example, a motion classification of “walking” followed by a motion classification of “sitting” may not indicate an exit event, but a motion classification of “sitting” followed by a motion classification of “walking” may indicate an exit event.

Motion classifications and displacements may be combined to identify exit events. For example, an exit event may be identified if a change in motion classification is detected and a net displacement exceed a threshold. In some embodiments, a displacement threshold for identifying an exit event may vary based on whether a change in motion classification is identified. For example, an exit event may be detected if a first displacement is exceeded, and, alternatively, an exit event may be identified if a change in motion classification is observed and a second displacement threshold is exceeded. The second displacement threshold can have a larger or smaller magnitude than the first displacement threshold depending on the movement classification.

The rules can include changes to a wireless fingerprint that can indicate an exit event. For instance, an exit event can be detected if a change in the signal strength for one or more wireless access points exceeds a threshold. The rules may include comparisons between wireless fingerprints corresponding to different time periods (e.g., different wake events). For example, an exit event may be identified if a sufficient number of wireless access points from a previous wireless fingerprint are no longer available (e.g., signals for the access points are no longer detected at the wireless circuitry 1510). In addition, or alternatively, an exit event may be identified if a sufficient number of wireless access points that were not present in a previous wireless fingerprint are now available (e.g., their signals are detectible by the wireless circuitry 1510). The rules may identify an exit event if a previously connected wireless access point is disconnected (e.g., no longer used to access a network), or a previously unconnected wireless access point is connected.

### C. Sequence Diagram for Detecting Exit Events

A mobile device may use both an application processor and a low power auxiliary processor to detect exit events. The application processor may be placed in a low-power mode to conserve the device's battery power. Between wake events, the mobile device's auxiliary processor (e.g., the auxiliary processor) can measure and store information that can be used for exit determinations. At wake events, the application processor can use the stored information to determine if an exit event has occurred.

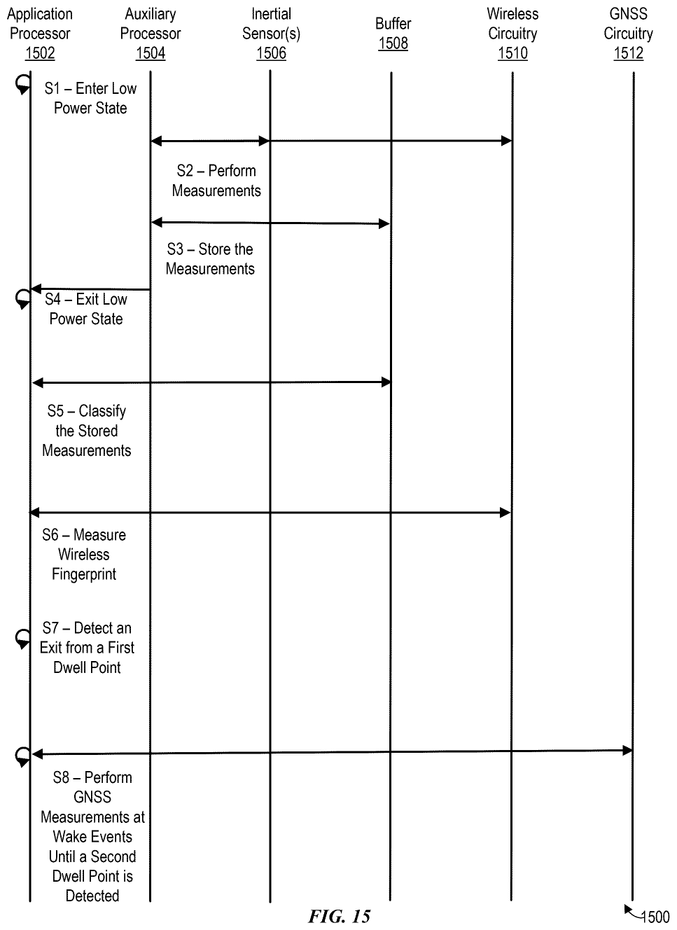

FIG. 15 is a sequence diagram 1500 showing a technique for identifying exit events according to various embodiments. At S1, an application processor 1502 can enter a low power state. Entering a low power state can mean that the clock rate for the application processor is reduced for the duration of the low power state.

At S2, the auxiliary processor 1504 and the inertial sensor(s) 1506 can perform measurements. To perform the measurements, the inertial sensor(s) 1506 can record inertial measurements and provide the measurements to the auxiliary processor. In some embodiments, the auxiliary processor 1504 may perform measurements by measuring the wireless signals received at the wireless circuitry. The measured wireless signals can be a wireless fingerprint.

At S3, the auxiliary processor 1504 can store the measurements to a buffer 1508. The buffer can contain raw measurements, or the measurements may be processed by the auxiliary processor 1504 before the measurements are stored to the buffer 1508. The buffer 1508 can contain the measurements that were performed by the auxiliary processor 1504 since the application processor entered a low power state at S1.

At S4, the application processor 1502 can exit the low power state. The application processor 1502 may exit the low power state at regular intervals (e.g., every 1 second, every 13 seconds, every 15 seconds, every 30 seconds, every minute, and every five minutes) or in response to an input received at the application processor 1502. In some embodiments, the auxiliary processor 1504 can instruct the application processor 1502 to exit the low power state. For example, the auxiliary processor 1504 may wake the application processor 1502 in response to the number of measurements in the buffer 1508 exceeding a threshold, the auxiliary processor 1504 receiving an indication of a connection or disconnection from a wireless access point, or a displacement calculated by the auxiliary processor 1504 from inertial measurements exceeding a threshold.

At S5, the application processor 1502 can classify the measurements in the buffer 1508 to determine inertial classification. Classifying the measurements may mean any combination of comparing the measurement to one or more rules or providing the measurements as inputs to one or more machine learning models. For example, the application processor 1502 can classify the measurements as corresponding to a displacement (e.g., a change in distance and direction) for the mobile device. In addition, or alternatively, the application processor can classify a motion type for the measurements (e.g., walking, jumping, running, swimming, biking, climbing, etc.).

The motion classification can be performed by the displacement module, e.g., as described herein, such as section I.C. As an example, the displacement module can determine whether movement exceeds a threshold within a given time period, and if so then the module can determine a movement state is present. Different thresholds can differentiate between different movements states, e.g., walking, running, biking, and driving, each with increasing values for the thresholds for the motion. As further examples, a moving average can be taken over time or a majority vote of recent time periods over a larger time interval, where the state classification of the time interval is determined based on the most common state determined for the time periods in a given time interval. In other implementations, a machine learning model can use various measurements, e.g., from an accelerometer, magnetometer, gyroscope, wireless network signals, and GPS.

At S6, the application processor 1502 can measure the signals received at the wireless circuitry to measure a wireless fingerprint. Wireless fingerprints are described in greater detail throughout this disclosure, and, in particular, with reference to FIG. 12. The wireless fingerprint can be any combination of a list of wireless access points for which signals have been received at the wireless circuitry within a threshold amount of time, a signal strength for some or all of those signals (e.g., received signal strength indicator (RSSI)), and any wireless access points that the device is connected to.

At S7, the application processor 1502 can use the classified measurements (e.g., the inertial classifications) from S5 and the wireless fingerprint form S6 to detect an exit from a first dwell point. As examples, the application processor 1502 may detect an exit if one or more rules is satisfied. The rules are described in greater detail above in section II.B.

In addition or alternatively, the measurements from S5 and the wireless fingerprint from S6 may be provided as an input to one or more machine learning models and the output of those one or more models may be a probability that an exit event has occurred. Machine learning models are described in greater detail with reference to section I.C and section III of this disclosure. The detected exit may be a probability that an exit is likely within a threshold amount of time and the mobile device may not need to leave the dwell point for an exit to be detected.

At S8, the application processor 1502 instruct the wireless circuitry 1512 to perform GNSS measurements. The GNSS measurements can be used by the application processor 1502 to determine the location of the mobile device. The application processor 1502 may return to the low power state between GNSS measurements and the processor may leave the low power state at regular intervals to perform the GNSS measurements. In some embodiments, the application processor 1502 may opportunistically perform GNSS measurements at points when the user's input to the mobile device causes the application processor 1502 to leave the low power state. These GNSS measurements can be performed until the application processor 1502 determines that the device has reached a dwell point.

### D. Flow

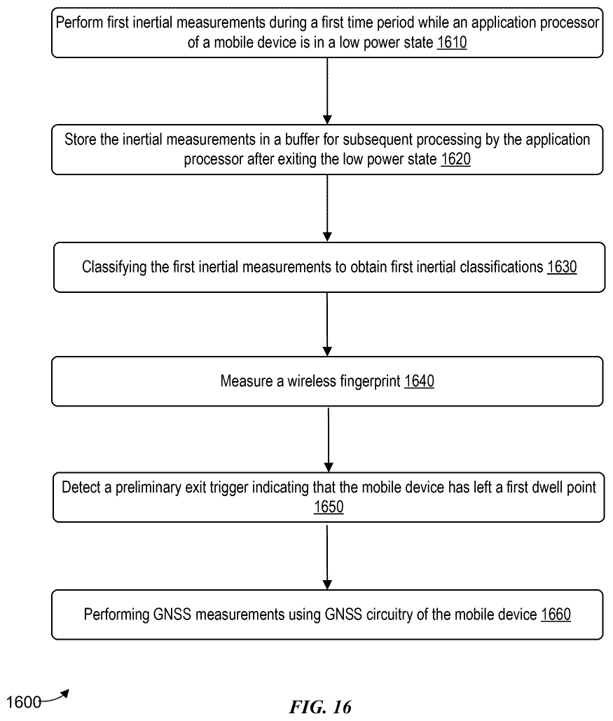

FIG. 16 is a flowchart illustrating a method 1600 for identifying exit events according to various embodiments. In some implementations, one or more method blocks of FIG. 16 may be performed by a mobile device (e.g., user equipment 12, architecture 1200, electronic device 2000). In some implementations, one or more method blocks of FIG. 16 may be performed by another device or a group of devices separate from or including the mobile device. Additionally, or alternatively, one or more method blocks of FIG. 16 may be performed by one or more components of the mobile device, such as processor 22, memory 24, nonvolatile storage 26, input structures 30, network interface 34, sensors 37, GNSS receiver 128, antenna 130, application processor 1205, receiver 1210, antenna 1225a-425n, input components 1250, wireless circuitry 1265, auxillary processor 1270, inertial sensor(s) 1280, processor 2018, computer-readable medium 2002, Input/Output (I/O) subsystem 2006, wireless circuitry 2008, etc.

At block 1610, first inertial measurements can be performed during a first time period while the application processor of a mobile device is in a low power state. The first inertial measurements can be performed by an auxiliary processor (e.g., always-on processor). The auxiliary processor may be powered on more often than the application processor.

At block 1620, the first inertial measurements from 1610 can be stored in a buffer. The first inertial measurements can be stored for subsequent processing by the application processor when the processor leaves the low power state. The application processor may leave a low power state in at regular intervals (e.g., at the conclusion of a low power state timer). The application processor may leave the low power state in response to an amount of input to the input components of the mobile device exceeding a threshold.

At block 1630, the first inertial measurements that were stored to the buffer at 1620 can be classified to obtain first inertial classifications. The first inertial measurements can be classified by the application processor after the processor leaves the low power state. The application processor may leave a low power state in response to a wake event. A wake event can include the conclusion of a low power state timer, or an amount of input to the input devices of the mobile device exceeding a threshold. The first inertial classifications can include any combination of a distance, a direction, and a motion type. The motion type can include any combination of walking, running, standing, sitting, laying down, jumping, playing sports, hiking, biking, rowing, and riding in a vehicle.

At block 1640, the output of the wireless circuitry of the mobile device can be measured to generate a wireless fingerprint. The wireless fingerprint can be a list of wireless access points for which signals have been received at the wireless circuitry. The wireless fingerprint can include the signal strength of one or more of the received signals from the wireless access points. The wireless fingerprint may indicate that the mobile device has not received any signals from wireless access points. The wireless fingerprint may indicate that the mobile device is communicably connected to a wireless access point.

At block 1650, an exit trigger can be detected based on the first inertial classifications from 1630 and the wireless fingerprint from 1640. The exit trigger can be a preliminary exit trigger in some embodiments. The exit trigger can be detected based on comparing the inertial classifications to threshold. The inertial classifications can be a probability or a confidence score that an exit event has occurred. The exit trigger can be classified as a preliminary exit trigger if the probability of the inertial classifications exceeds a first threshold but is below a second threshold that is higher than the first threshold. The exit trigger can be classified as a confirmed exit threshold if the probability of the inertial thresholds exceeds both the first threshold and the second threshold. The application processor may classify second inertial measurements and a second wireless fingerprint to generate second inertial classifications. The inertial classifications can a binary value indicating that the inertial measurements satisfied one or more rules. A preliminary exit event may be classified as a confirmed exit event if the inertial measurements corresponding to a threshold number of consecutive wake events satisfy the one or more rules.

At block 1660, GNSS measurements can be performed using GNSS circuitry of the mobile device. The GNSS measurements may be performed at a first active rate in response to the detection of a preliminary exit trigger. The GNSS measurements may be performed at a second active rate that is higher than the first active rate in response to the preliminary exit event being classified as a confirmed exit event.

Method 1600 may include additional implementations, such as any single implementation or any combination of implementations described below and/or in connection with one or more other processes described elsewhere herein.

Although FIG. 16 shows example blocks of method 1600, in some implementations, method 1600 may include additional blocks, fewer blocks, different blocks, or differently arranged blocks than those depicted in FIG. 16. Additionally, or alternatively, two or more of the blocks of method 1600 may be performed in parallel.

### VI. Model Training

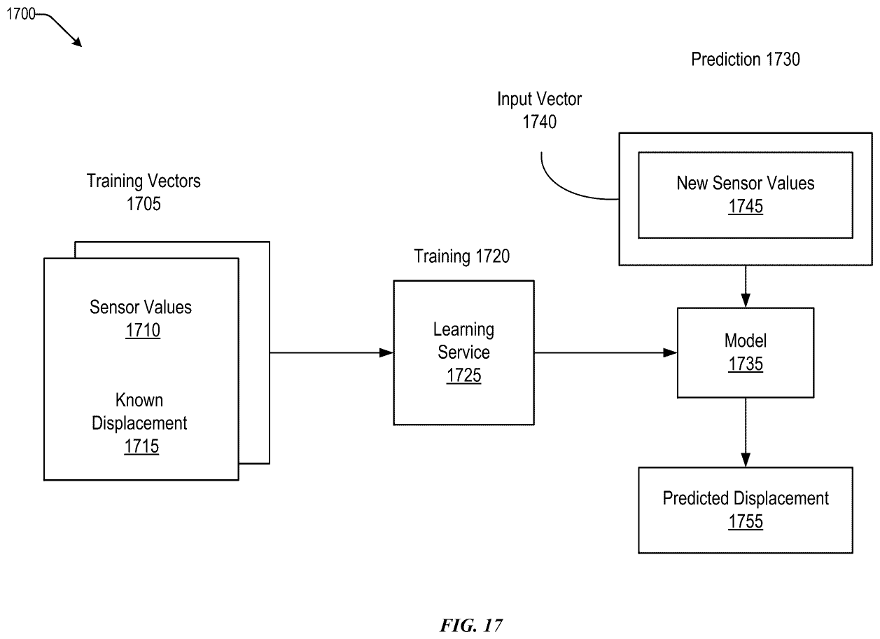

FIG. 17 depicts an architecture for training a machine learning model according to the embodiments of the present disclosure. Training vectors 1705 are shown with sensor values 1710 and a known displacement 1715. Sensor values 1710 can include the output of IMU sensors including gyroscopes, magnetometers, accelerometers, etc. For ease of illustration, only two training vectors are shown, but the number of training vectors may be much larger, e.g., 10, 170, 100, 1,000, 10,000, 100,000, or more. Training vectors could be made for different physical environments, the same physical environment over different time periods.

Sensor values 1710 have property fields that can correspond to the sensor values output by the IMU sensor(s) of a target mobile device and the skilled person will appreciate the various ways that such sensor values can be configured. Known displacements 1715 include the position of an electronic device during a time period that corresponds to the time the sensor value 1710 were recorded. For example, the known displacement can be determined by an electronic device using visual odometry, or visual inertial odometry, techniques. The known displacement 1715 can be coordinates and an orientation within a reference frame. The known displacement 1715 can be determined by the same device that generated the sensor values 1710, or the known displacement 1715 and the sensor values 1710 can be generated by separate devices. For example, a mobile device with a camera can be mounted at a fixed position on an individual (e.g., on the individual's chest or on top of the individual's head). As the individual moves around a physical environment, the mounted mobile device can compare sequential images to track the mounted device's position and orientation in the environment. A second mobile device can concurrently record sensor values 1710 as the individual moves around the environment. The training vector can include a known displacement 1715 and the sensor values 1710 that correspond to that displacement. A training vector 1705 may include information about the individual that was used to record the information in the vector (e.g., height, weight, age, etc.).

Training vectors 1705 can be used by a learning service 1725 to perform training 1720. A service, such as learning service 1725, being one or more computing devices configured to execute computer code to perform one or more operations that make up the service. Learning service 1725 can optimize parameters of a model 1735 such that a quality metric (e.g., accuracy of model 1735) is achieved with one or more specified criteria. The accuracy may be measured by comparing known displacements 1715 to predicted displacements. Parameters of model 1735 can be iteratively varied to increase accuracy. Determining a quality metric can be implemented for any arbitrary function including the set of all risk, loss, utility, and decision functions.

In some embodiments of training, a gradient may be determined for how varying the parameters affects a cost function, which can provide a measure of how accurate the current state of the machine learning model is. The gradient can be used in conjunction with a learning step (e.g., a measure of how much the parameters of the model should be updated for a given time step of the optimization process). The parameters (which can include weights, matrix transformations, and probability distributions) can thus be optimized to provide an optimal value of the cost function, which can be measured as being above or below a threshold (i.e., exceeds a threshold) or that the cost function does not change significantly for several time steps, as examples. In other embodiments, training can be implemented with methods that do not require a hessian or gradient calculation, such as dynamic programming or evolutionary algorithms.

A prediction stage 1730 can provide a predicted displacement 1755 for a new entity's entity signature vector 1740 based on new sensor values 1745. The predicted displacement 1755 can be a predicted speed for the tracking mobile device corresponding to the input vector 1740. The new sensor values can be of a similar type as sensor values 1710. If new sensor values are of a different type, a transformation can be performed on the data to obtain data in a similar format as sensor values 1710. Ideally, predicted displacement 1755 corresponds to the true displacement for input vector 1740.

A “machine learning model” (ML model) can refer to a software module configured to be run on one or more processors to provide a classification or numerical value of a property of one or more samples. An ML model can be generated using sample data (e.g., training data) to make predictions on test data. One example is an unsupervised learning model. Another example type of model is supervised learning that can be used with embodiments of the present disclosure. Example supervised learning models may include different approaches and algorithms including analytical learning, statistical models, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

Examples of machine learning models include deep learning models, neural networks (e.g., deep learning neural networks), kernel-based regressions, adaptive basis regression or classification, Bayesian methods, ensemble methods, logistic regression and extensions, Gaussian processes, support vector machines (SVMs), a probabilistic model, and a probabilistic graphical model. Embodiments using neural networks can employ using wide and tensorized deep architectures, convolutional layers, dropout, various neural activations, and regularization steps.

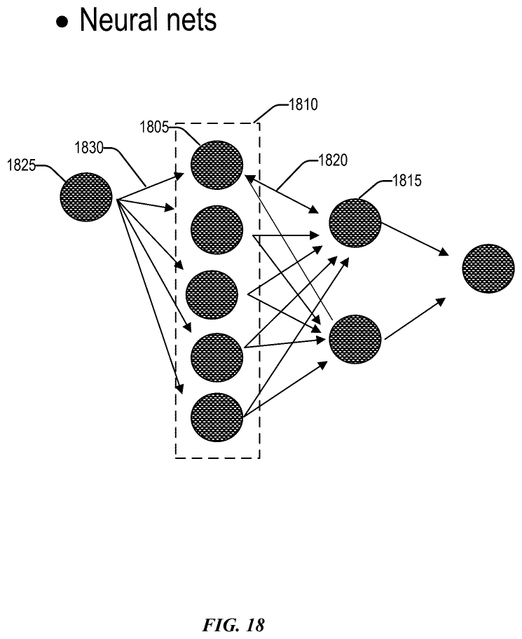

FIG. 18 shows an example machine learning model of a neural network. As an example, model 1835 can be a neural network that comprises a number of neurons (e.g., Adaptive basis functions) organized in layers. For example, neuron 1805 can be part of layer 1810. The neurons can be connected by edges between neurons. For example, neuron 1805 can be connected to neuron 1815 by edge 1820. A neuron can be connected to any number of different neurons in any number of layers. For instance, neuron 1805 can be connected to neuron 1825 by edge 1830 in addition to being connected to neuron 1815.

The training of the neural network can iteratively search for the best configuration of the parameter of the neural network for feature recognition and prediction performance. Various numbers of layers and nodes may be used. A person with skills in the art can easily recognize variations in a neural network design and design of other machine learning models. For example, neural networks can include graph neural networks that are configured to operate on unstructured data. A graph neural network can receive a graph (e.g., nodes connected by edges) as an input to the model and the graph neural network can learn the features of this input through pairwise message passing. In pairwise message passing, nodes exchange information and each node iteratively updates its representation based on the passed information. More detail about graph neural networks can be found in the following reference: Wu, Zonghan, et al. “A comprehensive survey on graph neural networks.” IEEE transactions on neural networks and learning systems 32.1 (2020): 8-2 8.

### VII. Example Auxiliary Processor Architecture

As described herein, the ability to collect location data (or information) and generate accurate locations can provide benefits and services to the users. However, a large amount of historical location data may need to be stored while the mobile device is in a low-power state (e.g., sleep mode).

An auxiliary processor architecture can utilize a certain part of storage space (e.g., cache memory of a main processor and referred to herein as cache) of a mobile device that is not being used while the main processor (e.g., application processor (AP)) is in a low-power mode (e.g., a sleep mode) to store historical location data. After the AP wakes up (i.e., exits the sleep mode), the stored historical location data can be moved from the cache memory (e.g., static random-access memory (SRAM)) to larger system memory (e.g., dynamic random-access memory (DRAM)), where the AP can access and process the stored historical location data while performing its normal function to use its cache memory. The auxiliary processor (e.g., an always-on processor) is powered on more often than the application processor.

a. System Components

The always-on system architecture may include one or more processors and various components (e.g., sensors, storage, interfaces, etc.) to provide the always-on functionality and experience to a user of a mobile device. The architecture may be implemented on a system-on-chip (SoC) or a circuit board to tightly integrate the components.

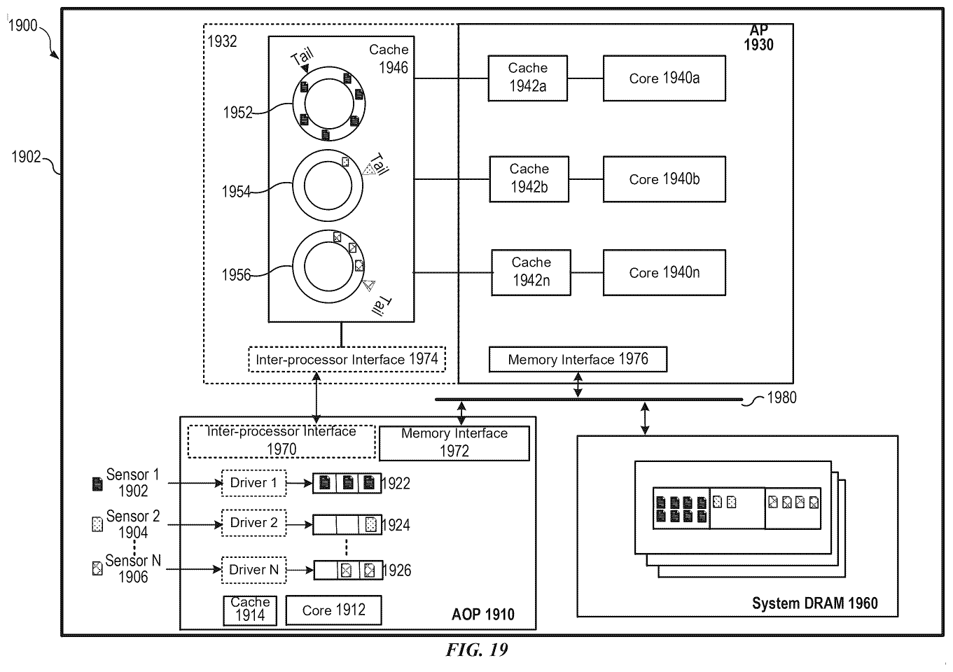

FIG. 19 is a block diagram of an example always-on system architecture 1900, which may include a system-on-chip (SoC) 1902 in a mobile device. In some embodiments, 1902 may be a circuit board. The architecture 1900 may be a multiprocessor system. SoC 1902 may include an always-on processor (AOP) 1910, an application processor (AP) 1930, system memory (e.g., DRAM) 1960, and cache memory 1946 (referred to as cache) in a module 1932 that may or may not be part of AP 1930.

It should be apparent that the architecture 1900 shown in FIG. 19 is only one example, and that SoC 1902 can have more or fewer components than shown, or a different configuration of components. The various components shown in FIG. 19 can be implemented in hardware, software, or a combination of both hardware and software, including one or more signal processing and/or application specific integrated circuits. In some embodiments, AOP 1910 and AP 1930 may be different integrated circuits (ICs referred to as chips) on a circuit board.

In FIG. 19, AOP 1910 may be a small, low-power auxiliary processor that is always active for interacting with sensors, handling background operations, and waking up the operating system running on AP 1930. Sensor measurements related to locations are referred to herein as location data. AOP 1910 may have one or more processor cores 1912 and local cache 1914. One or more small buffers (e.g., 1922, 1924, and 1926) can be used to temporarily store location data from various sensors (e.g., sensor 1 1902, sensor 2 1904, and sensor N 1906), one buffer per sensor (e.g., buffer 1922 for sensor 1 1902, buffer 1924 for sensor 2 1904, and buffer 1926 for sensor N 1906). In some embodiments, a shared buffer space may be used to store data for all sensors. AOP may also include, but is not limited to, an inter-processor interface 1970 for communicating with another processor (e.g., AP 1930) and a memory interface 1972 for accessing system DRAM 1960.

The sensors 1902-1906 may be different location technologies, such as wireless fidelity (Wi-Fi), Bluetooth (BT), Bluetooth Low Energy or BLE, Global Positioning System (GPS), ultrawideband (UWB), etc. The raw location data from the sensors may be processed by their respective drivers before being placed into a buffer for each sensor.

AP 1930 may be the main processor on a mobile device (e.g., phone or wearable watch) for processing data and performing user-facing tasks. The AP 1930 may be a single or multicore processor (e.g., cores 1940a-1940n). Each core may have a small local cache (e.g., layer-1 (L1) cache) tightly integrated with the core. The AP 1930 may also have one or more larger caches 1946, such as layer-2 (L2) or layer-3 (L3) cache, that may or may not be integrated with the AP (i.e., on the same chip). The AP 1930 may also include, but is not limited to, an inter-processor interface 1940 for communicating with another processor (e.g., AOP 1910) and a memory interface 1972 for accessing system DRAM 1960.

The cache 1946 that can be accessed by both AOP 1910 and AP 1930 may be on the SoC 1902. In some embodiments, the cache 1946 (e.g., L2 or L3 cache for AP) may be integrated with and become part of AP 1930. In that case, AOP 1910 may communicate with and access the cache 1946 through the inter-processor interface 1970 of AOP 1910 and the inter-processor interface 1974 of AP 1930. The inter-processor interfaces (1970 and 1974) may include various cache coherency mechanisms for maintaining cache coherence between AP 1930 and AOP 1910, as well as secured communication mechanisms. In other embodiments, the cache 1946 may be separated from (or not integrated with) AP 1930. As a result, AOP 1910 may communicate with and access the cache 1946 directly without using the inter-processor interfaces (1970 and 1974). In such case, cache coherency and secured communication mechanisms may be supported by other components (not shown) on the SoC 1902.

A bus subsystem 1980 may provide a mechanism for various components and subsystems to communicate with each other. For example, AOP 1910 and AP 1930 may access system memory 1960 using their respective memory interfaces 1972 and 1976.

System memory 1960 may provide temporary data storage for AP 1930 to access and execute programs or applications. System memory 1960 typically includes Dynamic Random-Access Memory (DRAM) in large quantity to store a large amount of data, and is shared among processors (e.g., AOP 1910 and AP 1930).

### B. System Operations and Data Flow

As discussed above, the always-on system architecture 1900 may provide an all-day buffering capability to temporarily store location data from various sensors when the AP 1930 is not active, such as in sleep mode. Once AP 1930 wakes up and becomes active, the buffered location data can be processed. Since different parts of the storage space on the SoC 1902 may be available when the AP 1930 is asleep or awake, the temporarily stored location data may be moved depending on AP's status to make the best use of under-utilized resources and conserve power consumption.

For example, typically, processor cache memory may be implemented with static random-access memory (SRAM) in small quantities with faster access speed. The processor cache is available to use even when AP is asleep. On the other hand, system memory may be implemented in dynamic random-access memory (DRAM) in large quantities with slower access speed. DRAM may need to be constantly refreshed, and not available to use when AP is asleep to save power.

Because the cache 1946 and the system DRAM 1960 are available at different times, the AOP 1910 may be configured to transfer or move the stored historical location data at the appropriate time.

As mentioned above, historical location data from sensors (1902-1906) may be temporarily stored in their corresponding buffers (1922-1926) in AOP 1910. The data in each buffer may then be securely transferred to the cache 1946 (through inter-processor interfaces 1970 and 1974 or not) when more data arrives. The storage space in the cache 1946 may be organized into multiple circular buffers or queues (1952-1956), one for location data from each sensor, for example, circular buffer 1952 for sensor 1 1902, circular buffer 1954 for sensor 2 1904, and circular buffer 1956 for sensor N 1906. A circular buffer may hold a duration of location data (e.g., 15 minutes to an hour or more). Once the capacity of the circular buffer is reached, new data may overwrite the old data. Thus, each circular buffer may have an indicator (“tail”) indicating the start/end of its stored content. In some embodiments, the storage space in the cache 1946 may not be partitioned but used for storing location data from all sensors by using an identifier for each sensor, for example, ID 1 for sensor 1's data 1902, ID2 for sensor 2's data 1924, etc.

When AP 1930 wakes up, AOP 1910 may move the stored historical location data in cache 1946 to system DRAM 1960 via memory interface 1972 and bus subsystem 1980 using a security protocol. The security protocol may ensure the data being transferred is tempered proof. The AP 1930 can then access the historical location data from the system DRAM 1960 via its memory interface 1976 and bus subsystem 1980. In some embodiments, the AP 1930 can start accessing and processing the historical location data in the system DRAM 1960 once the data is available and before the AOP 1910 completes the data transfer. In other words, the cache 1946 of the always-on system architecture 1900 may act as a store-and-forward buffer.

### VIII. Example Device

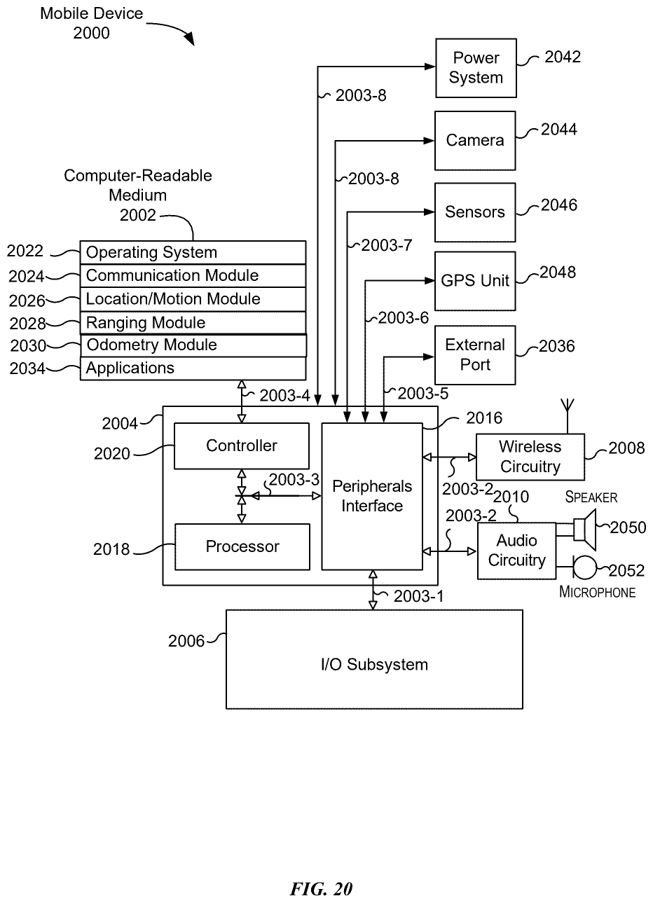

FIG. 20 is a block diagram of an example electronic device 2000 according to various embodiments. Device 2000 generally includes computer-readable medium 2002, a processing system 2004, an Input/Output (I/O) subsystem 2006, wireless circuitry 2008, and audio circuitry 2010 including speaker 2012 and microphone 2014. These components may be coupled by one or more communication buses or signal lines 2003. Device 2000 can be any portable electronic device, including a handheld computer, a tablet computer, a mobile phone, laptop computer, tablet device, media player, personal digital assistant (PDA), a key fob, a car key, an access card, a multifunction device, a mobile phone, a portable gaming device, a headset, or the like, including a combination of two or more of these items.

it should be apparent that the architecture shown in FIG. 20 is only one example of an architecture for device 2000, and that device 2000 can have more or fewer components than shown, or a different configuration of components. The various components shown in FIG. 20 can be implemented in hardware, software, or a combination of both hardware and software, including one or more signal processing and/or application specific integrated circuits.

Wireless circuitry 2008 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 2008 can use various protocols, e.g., as described herein. In various embodiments, wireless circuitry 2008 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 902.11a, IEEE 902.11b, IEEE 902.11g and/or IEEE 902.11n), Bluetooth, Wi-MAX, Voice Over Internet Protocol (VoIP), near field communication protocol (NFC), a protocol for email, instant messaging, and/or a short message service (SMS), or any other suitable communication protocol, including communication protocols not yet developed as of the filing date of this document.

Wireless circuitry 2008 is coupled to processing system 2004 via peripherals interface 2016. Peripherals interface 2016 can include conventional components for establishing and maintaining communication between peripherals and processing system 2004. Voice and data information received by wireless circuitry 2008 (e.g., in speech recognition or voice command applications) is sent to one or more processors 2018 via peripherals interface 2016. One or more processors 2018 are configurable to process various data formats for one or more application programs 2034 stored on medium 2002.

Peripherals interface 2016 couple the input and output peripherals of device 2000 to the one or more processors 2018 and computer-readable medium 2002. One or more processors 2018 communicate with computer-readable medium 2002 via a controller 2020. Computer-readable medium 2002 can be any device or medium that can store code and/or data for use by one or more processors 2018. Computer-readable medium 2002 can include a memory hierarchy, including cache, main memory and secondary memory. The memory hierarchy can be implemented using any combination of random access memory (RAM) (e.g., static random access memory (SRAM,) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 2016, one or more processors 2018, and controller 2020 can be implemented on a single chip, such as processing system 2004. In some other embodiments, they can be implemented on separate chips.

Processor(s) 2018 can include hardware and/or software elements that perform one or more processing functions, such as mathematical operations, logical operations, data manipulation operations, data transfer operations, controlling the reception of user input, controlling output of information to users, or the like. Processor(s) 2018 can be embodied as one or more hardware processors, microprocessors, microcontrollers, field programmable gate arrays (FPGAs), application-specified integrated circuits (ASICs), or the like.

Device 2000 also includes a power system 2042 for powering the various hardware components. Power system 2042 can include a power management system, one or more power sources (e.g., battery, alternating current (AC)), a recharging system, a power failure detection circuit, a power converter or inverter, a power status indicator (e.g., a light emitting diode (LED)), and any other components typically associated with the generation, management and distribution of power in mobile devices.

In some embodiments, device 2000 includes a camera 2044. In some embodiments, device 2000 includes sensors 2046. Sensors can include accelerometers, compass, gyrometer, pressure sensors, audio sensors, light sensors, barometers, and the like. Sensors 2046 can be used to sense location aspects, such as auditory or light signatures of a location.

In some embodiments, device 2000 can include a GPS receiver, sometimes referred to as a GPS unit 2048. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 2018 run various software components stored in medium 2002 to perform various functions for device 2000. In some embodiments, the software components include an operating system 2022, a communication module 2024 (or set of instructions), a location module 2026 (or set of instructions), a ranging module 2028 that is used as part of ranging operation described herein, and other application programs 2034 (or set of instructions).

Operating system 2022 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 2024 facilitates communication with other devices over one or more external ports 2036 or via wireless circuitry 2008 and includes various software components for handling data received from wireless circuitry 2008 and/or external port 2036. External port 2036 (e.g., universal serial bus (USB), FireWire, Lightning connector, 70-pin connector, etc.) is adapted for coupling directly to other devices or indirectly over a network (e.g., the Internet, wireless local area network (LAN), etc.).

Location/motion module 2026 can assist in determining the current position (e.g., coordinates or other geographic location identifiers) and motion of device 2000. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 2026 receives data from GPS unit 2048 and analyzes the signals to determine the current position of the mobile device. In some embodiments, location/motion module 2026 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 2008 and is passed to location/motion module 2026. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 2000 based on the position coordinates of the corresponding transmitters. Regardless of the specific location technology used, location/motion module 2026 receives information from which a location fix can be derived, interprets that information, and returns location information, such as geographic coordinates, latitude/longitude, or other location fix data.

Ranging module 2028 can send/receive ranging messages to/from an antenna, e.g., connected to wireless circuitry 2008. The messages can be used for various purposes, e.g., to identify a sending antenna of a device, determine timestamps of messages to determine a distance of electronic device 2000 from another device. Ranging module 2028 can exist on various processors of the device, e.g., an always-on processor (AOP), a UWB chip, and/or an application processor. For example, parts of ranging module 2028 can determine a distance on an AOP, and another part of the ranging module can interact with a sharing module, e.g., to display a position of the other device on a screen in order for a user to select the other device to share a data item. Ranging module 2028 can also interact with a reminder module that can provide an alert based on a distance from another mobile device.

Odometry module 2030 can perform odometry techniques to determine the location and orientation of electronic device 2000 within a physical environment. Output from the camera 2044 and the sensors 2046 can be accessed by the odometry module 2030, and the odometry module 2030 can use this information to perform visual inertial odometry techniques. The odometry module 2030 can identify and compare features in sequential images captured by camera 2044 to determine the camera's movement relative to those features. The odometry module 2030 may use information from the sequential images to create a map of the environment. In addition or alternatively, inertial information from sensors 2046 can be used to estimate the movement of the electronic device 2000. Inertial information can include any combination of linear acceleration, angular acceleration, linear velocity, angular velocity, and magnetometer readings, and the inertial information can be in any number of axes.

The one or more applications 2034 on device 2000 can include any applications installed on the device 2000, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 2006 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 2006 can include a display and user input devices such as a keyboard, mouse, and/or trackpad. In some embodiments, I/O subsystem 2006 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 2002) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 2006 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 2000 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g. a solid-state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including an authentication tag and data from which the tag is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to authenticate another device, and vice versa to control which devices ranging operations may be performed. Further, other uses for personal information data that benefit the user are also contemplated by the present disclosure. For instance, health and fitness data may be shared to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

What is claimed is:

1. A method performed by a mobile device, the method comprising:
performing, by an auxiliary processor, first inertial measurements using one or more inertial sensors of the mobile device during a first time period while an application processor is in a low power state, wherein the auxiliary processor is powered on more often than the application processor;
storing, by the auxiliary processor, the first inertial measurements in a buffer for subsequent processing by the application processor after exiting the low power state;
after exiting the low power state, classifying, by the application processor, the first inertial measurements stored in the buffer to obtain first inertial classifications, the classifying performed in response to a wake event that causes the application processor to leave the low power state, the first inertial classifications comprising one or more inertial classifications corresponding to the first inertial measurements;
generating, by the application processor, a first wireless fingerprint using an output of a wireless circuitry of the mobile device;
detecting, by the application processor and based on the first inertial classifications and the first wireless fingerprint, a preliminary exit trigger indicating that the mobile device has left a first dwell point; and
responsive to the preliminary exit trigger indicating that a mobile device has left a first dwell point, performing first GNSS measurements using GNSS circuitry of the mobile device, the first GNSS measurements performed at a first active rate.

2. The method of claim 1, wherein the one or more inertial classifications comprise a motion type.

3. The method of claim 2, wherein the one or more inertial classifications further comprise a distance and a direction.

4. The method of claim 1, further comprising, at each wake event until the mobile device reaches a second dwell point:
logging, by the application processor, a GNSS location and a time for the mobile device at the wake event.

5. The method of claim 1, further comprising:
performing, by the auxiliary processor, second inertial measurements using the one or more inertial sensors of the mobile device during a second time period while the application processor is in the low power state;
storing, by the auxiliary processor, the second inertial measurements in the buffer for subsequent processing by the application processor after exiting the low power state;
after exiting the low power state, classifying, by the application processor, the second inertial measurements stored in the buffer to obtain second inertial classifications;
measuring, by the application processor, the output of the wireless circuitry to generate a second wireless fingerprint;
classifying, by the application processor and based on the second inertial classifications and the second wireless fingerprint, the preliminary exit trigger as a confirmed exit trigger; and
responsive to classifying the preliminary exit trigger, performing second GNSS measurements at a second active rate that is higher than the first active rate.

6. The method of claim 1, wherein the first wireless fingerprint comprises information identifying wireless access points for which signals have been received at the mobile device during a time period.

7. The method of claim 6, wherein the first wireless fingerprint further comprises a signal strength of each received signal.

8. The method of claim 1, wherein the first wireless fingerprint comprises information identifying a wireless access point that is communicably connected to the mobile device or information indicating that the mobile device is not communicably connected to any wireless access point.

9. The method of claim 1, wherein entering the low power state comprises:
changing a clock speed threshold from a first threshold to a second threshold, wherein the clock speed threshold is a maximum clock speed for the application processor and the first threshold is larger than the second threshold.

10. The method of claim 9, wherein leaving the low power state comprises:
changing the clock speed threshold from the second threshold to the first threshold.

11. The method of claim 10, wherein leaving the low power state further comprises:
measuring input to one or more input devices of the mobile device;
comparing the input to an input threshold; and
changing the clock speed threshold from the second threshold to the first threshold in response to the input exceeding the input threshold.

12. The method of claim 10, wherein leaving the low power state further comprises:
detecting a conclusion of a low power state timer;
changing the clock speed threshold from the second threshold to the first threshold in response to the conclusion of the low power state timer.

13. The method of claim 9, wherein entering the low power state further comprises:
measuring input to one or more input devices of the mobile device;
comparing the input to an input threshold; and
changing the clock speed threshold from the first threshold to the second threshold in response to the input threshold exceeding the input.

14. A mobile device, comprising:
one or more memories; and
one or more processors in communication with the one or more memories and configured to execute instructions stored in the one or more memories to perform operations to:
perform, by an auxiliary processor, first inertial measurements using one or more inertial sensors of the mobile device during a first time period while an application processor is in a low power state, wherein the auxiliary processor is powered on more often than the application processor;
store, by the auxiliary processor, the first inertial measurements in a buffer for subsequent processing by the application processor after exiting the low power state;
after exiting the low power state, classify, by the application processor, the first inertial measurements stored in the buffer to obtain first inertial classifications, the classifying performed in response to a wake event that causes the application processor to leave the low power state, the first inertial classifications comprising one or more inertial classifications corresponding to the first inertial measurements;
generate, by the application processor, a first wireless fingerprint using an output of a wireless circuitry of the mobile device;
detect, by the application processor and based on the first inertial classifications and the first wireless fingerprint, a preliminary exit trigger indicating that the mobile device has left a first dwell point; and
responsive to the preliminary exit trigger indicating that a mobile device has left a first dwell point, perform first GNSS measurements using GNSS circuitry of the mobile device, the first GNSS measurements performed at a first active rate.

15. The mobile device of claim 14, wherein the instructions further comprise operations to:
perform, by the auxiliary processor, second inertial measurements using the one or more inertial sensors of the mobile device during a second time period while the application processor is in the low power state;
store, by the auxiliary processor, the second inertial measurements in the buffer for subsequent processing by the application processor after exiting the low power state;
after exiting the low power state, classify, by the application processor, the second inertial measurements stored in the buffer to obtain second inertial classifications;
measure, by the application processor, the output of the wireless circuitry to generate a second wireless fingerprint;
classify, by the application processor and based on the second inertial classifications and the second wireless fingerprint, the preliminary exit trigger as a confirmed exit trigger; and
responsive to classifying the preliminary exit trigger, perform second GNSS measurements at a second active rate that is higher than the first active rate.

16. The mobile device of claim 14, wherein the first wireless fingerprint comprises information identifying wireless access points for which signals have been received at the mobile device during a time period.

17. The mobile device of claim 14, wherein the first wireless fingerprint comprises information identifying a wireless access point that is communicably connected to the mobile device or information indicating that the mobile device is not communicably connected to any wireless access point.

18. A non-transitory computer-readable medium storing a plurality of instructions that, when executed by one or more processors of a mobile device, cause the one or more processors to perform operations to:
perform, by an auxiliary processor, first inertial measurements using one or more inertial sensors of the mobile device during a first time period while an application processor is in a low power state, wherein the auxiliary processor is powered on more often than the application processor;
store, by the auxiliary processor, the first inertial measurements in a buffer for subsequent processing by the application processor after exiting the low power state;
after exiting the low power state, classify, by the application processor, the first inertial measurements stored in the buffer to obtain first inertial classifications, the classifying performed in response to a wake event that causes the application processor to leave the low power state, the first inertial classifications comprising one or more inertial classifications corresponding to the first inertial measurements;
generate, by the application processor, a first wireless fingerprint using an output of a wireless circuitry of the mobile device;
detect, by the application processor and based on the first inertial classifications and the first wireless fingerprint, a preliminary exit trigger indicating that the mobile device has left a first dwell point; and
responsive to the preliminary exit trigger indicating that a mobile device has left a first dwell point, perform first GNSS measurements using GNSS circuitry of the mobile device, the first GNSS measurements performed at a first active rate.

19. The non-transitory computer-readable medium of claim 18, wherein the instructions further comprise operations to:
perform, by the auxiliary processor, second inertial measurements using the one or more inertial sensors of the mobile device during a second time period while the application processor is in the low power state;
store, by the auxiliary processor, the second inertial measurements in the buffer for subsequent processing by the application processor after exiting the low power state;
after exiting the low power state, classify, by the application processor, the second inertial measurements stored in the buffer to obtain second inertial classifications;
measure, by the application processor, the output of the wireless circuitry to generate a second wireless fingerprint;
classify, by the application processor and based on the second inertial classifications and the second wireless fingerprint, the preliminary exit trigger as a confirmed exit trigger; and
responsive to classifying the preliminary exit trigger, perform second GNSS measurements at a second active rate that is higher than the first active rate.

20. The non-transitory computer-readable medium of claim 18, wherein the first wireless fingerprint comprises information identifying wireless access points for which signals have been received at the mobile device during a time period.
